(19) United States
(12) Patent Application Publication
(10) Pub. No.: US 2026/0162468 A1
(43) Pub. Date: Jun. 11, 2026

(54) SYSTEMS AND METHODS FOR PREDICTIVE DRIVING BEHAVIOR DETECTION

(71) Applicant: TOYOTA MOTOR ENGINEERING & MANUFACTURING NORTH AMERICA, INC., Plano, TX (US)

(72) Inventors: Seyhan Ucar, Mountain View, CA (US); Emrah Akin Sisbot, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/970,508

(22) Filed: Dec. 5, 2024

(51) Int. Cl. G07C 5/02

(52) U.S. Cl. CPC G07C 5/02

(57) ABSTRACT

Systems and methods are provided for refining predictive driving actions. The systems and methods may receive driving data of a vehicle. The driving data may be analyzed to determine a driving behavior of the vehicle. The systems and methods may infer characteristics of the driving behavior. A prediction model may be elected for use according to the characteristics. The prediction model may include a reckless behavior prediction model, aggressive behavior prediction model and distracted behavior prediction model. Using the elected prediction model, a predictive action of the vehicle may be determined according to the driving data and environmental data of the vehicle. The systems and methods may monitor the vehicle to determine a next action of the vehicle. The next action may be analyzed to determine if it matches the predictive action. The systems and methods may refine the prediction model according to the analysis of the next action.

### TECHNICAL FIELD

The present disclosure relates generally to the detection of anomalous driving, and more particularly, some aspects of the system and methods described herein relate to a method and system for refining predictive analysis of the driving behavior of a vehicle when unsafe driving is detected.

### BACKGROUND OF THE INVENTION

A vehicle performing anomalous driving behavior can lead to unsafe driving that abuses or jeopardizes the safety of the vehicle and its driver, as well as the safety of other vehicles and persons. Unsafe driving behavior may be characterized as (i) aggressive driving, including, for example, tailgating or lane-cutting, (ii) distracted driving, including, for example, swerving or delayed driver reactions, or (iii) reckless driving, including, for example, green light running or lane changing without signaling. Studies show that (i) more than half of accidents include at least one aggressive driver, (ii) more than 80% of drivers in the U.S. have engaged in distracted driving, and (iii) the most frequent type of collision in the U.S. is rear-end collision, which is mainly caused by distracted or reckless driving behavior of follower vehicles. To address these issues and help prevent accidents caused by unsafe driving behavior, early and accurate detection of unsafe driving behaviors is important and critical in performing predictive analysis to generate preventative actions. Systems are needed to analyze detected unsafe driving behaviors and refine predictive analysis to ensure accurate preventative actions are generated.

### BRIEF SUMMARY OF THE DISCLOSURE

According to various aspects of the disclosed technology, systems and methods for refining predictive driving actions are provided.

In accordance with some implementations, a method for refining predictive driving actions is provided. The method may include: analyzing driving data of a vehicle to determine a driving behavior of the vehicle; inferring, based on the determined driving behavior, a characteristic of the driving behavior; electing a prediction model according to the characteristic; determining, using the prediction model, a predictive action of the vehicle according to environmental data of the vehicle; monitoring the vehicle to determine a next action of the vehicle; analyzing the next action to determine whether the next action matches the predictive action; and refining the prediction model according to the analysis of the next action.

In some applications, the driving data of the vehicle may include an identity of a driver of the vehicle.

In some applications, the driving behavior of the vehicle may include one or more actions performed by the vehicle while in motion.

In some applications, the characteristic of the driving behavior may include a type of action performed by the vehicle, degree of repetition of the type action, motion pattern, period of the motion pattern and degree of influence.

In some applications, the type of action may include nudging, accelerations, decelerations, braking, weaving, swerving, failure to signal, tailgating, lane drifting, failure to stop, speeding, driving slow, delayed stopping, delayed accelerations, honking, flashing headlights and lack of headlights.

In some applications, the prediction model may include at least one of a group consisting of reckless behavior prediction model, aggressive behavior prediction model and distracted behavior prediction model.

In some applications, each prediction model may be generated according to driving data of a plurality of vehicles.

In some applications, the environmental data may include traffic, traffic signs, weather, road conditions and information on surroundings of the vehicle.

In some applications, the determining the predictive action of the vehicle may be further based on stored driving data of the driver of the vehicle.

In some applications, the method may further include: determining the predictive action of the vehicle is an unsafe action; and notifying a first driver of a first vehicle of the predictive action of the vehicle, with the first vehicle being in a position of danger from the predictive action of the vehicle.

In some applications, the determining the predictive action of the vehicle is an unsafe action may be based on a driving detection algorithm associated with the prediction model.

In some applications, the unsafe action may include multiple nudging, frequent accelerations, frequent decelerations, frequent braking, frequent weaving, frequent swerving, frequent headlight flashing, prolonged tailgating, aggressive speeding and driving through intersections without stopping.

In some applications, the refining the prediction model may include generating a new rule on driving behavior characteristic inference.

In another aspect, a system for refining predictive driving actions is provided that may include one or more processors; and memory coupled to the one or more processors to store instructions, which when executed by the one or more processors, may cause the one or more processors to perform operations. The operations may include: analyzing driving data of a vehicle to determine a driving behavior of the vehicle; inferring, based on the determined driving behavior, a characteristic of the driving behavior; electing a prediction model according to the characteristic; determining, using the prediction model, a predictive action of the vehicle according to environmental data of the vehicle; monitoring the vehicle to determine a next action of the vehicle; analyzing the next action to determine whether the next action matches the predictive action; and refining the prediction model according to the analysis of the next action.

In some applications, the driving data of the vehicle may include an identity of a driver of the vehicle.

In some applications, the driving behavior of the vehicle may include one or more actions performed by the vehicle while in motion.

In some applications, the characteristic of the driving behavior may include a type of action performed by the vehicle, degree of repetition of the type of action, motion pattern, period of the motion pattern and degree of influence.

In some applications, the type of action may include nudging, accelerations, decelerations, braking, weaving, swerving, failure to signal, tailgating, lane drifting, failure to stop, speeding, driving slow, delayed stopping, delayed accelerations, honking, flashing headlights and lack of headlights.

In some applications, the prediction model may include at least one of a group consisting of reckless behavior prediction model, aggressive behavior prediction model and distracted behavior prediction model.

In some applications, each prediction model may be generated according to driving data of a plurality of vehicles.

In some applications, the environmental data may include traffic, traffic signs, weather, road conditions and information on surroundings of the vehicle.

In some applications, the determining the predictive action of the vehicle may be further based on stored driving data of the driver of the vehicle.

In some applications, the system may further include operations comprising: determining the predictive action of the vehicle is an unsafe action; and notifying a first driver of a first vehicle of the predictive action of the vehicle, with the first vehicle being in a position of danger from the predictive action of the vehicle.

In some applications, the determining the predictive action of the vehicle is an unsafe action may be based on a driving detection algorithm associated with the prediction model.

In some applications, the unsafe action may include multiple nudging, frequent accelerations, frequent decelerations, frequent braking, frequent weaving, frequent swerving, frequent headlight flashing, prolonged tailgating, aggressive speeding and driving through intersections without stopping.

In some applications, the refining the prediction model may include generating a new rule on driving behavior characteristic inference.

In another aspect, a non-transitory machine-readable medium is provided. The non-transitory computer-readable medium may include instructions that when executed by a processor may cause the processor to perform operations including: analyzing driving data of a vehicle to determine a driving behavior of the vehicle; inferring, based on the determined driving behavior, a characteristic of the driving behavior; electing a prediction model according to the characteristic; determining, using the prediction model, a predictive action of the vehicle according to environmental data of the vehicle; monitoring the vehicle to determine a next action of the vehicle; analyzing the next action to determine whether the next action matches the predictive action; and refining the prediction model according to the analysis of the next action.

In some applications, the driving data of the vehicle may include an identity of a driver of the vehicle.

In some applications, the driving behavior of the vehicle may include one or more actions performed by the vehicle while in motion.

In some applications, the characteristic of the driving behavior may include a type of action performed by the vehicle, degree of repetition of the type of action, motion pattern, period of the motion pattern and degree of influence.

In some applications, the type of action may include nudging, accelerations, decelerations, braking, weaving, swerving, failure to signal, tailgating, lane drifting, failure to stop, speeding, driving slow, delayed stopping, delayed accelerations, honking, flashing headlights and lack of headlights.

In some applications, the prediction model may include at least one of a group consisting of reckless behavior prediction model, aggressive behavior prediction model and distracted behavior prediction model.

In some applications, each prediction model may be generated according to driving data of a plurality of vehicles.

In some applications, the environmental data may include traffic, traffic signs, weather, road conditions and information on surroundings of the vehicle.

In some applications, the determining the predictive action of the vehicle may be further based on stored driving data of the driver of the vehicle.

In some applications, the non-transitory machine-readable medium may further include operations comprising: determining the predictive action of the vehicle is an unsafe action; and notifying a first driver of a first vehicle of the predictive action of the vehicle, with the first vehicle being in a position of danger from the predictive action of the vehicle.

In some applications, the determining the predictive action of the vehicle is an unsafe action may be based on a driving detection algorithm associated with the prediction model.

In some applications, the unsafe action may include multiple nudging, frequent accelerations, frequent decelerations, frequent braking, frequent weaving, frequent swerving, frequent headlight flashing, prolonged tailgating, aggressive speeding and driving through intersections without stopping.

In some applications, the refining the prediction model may include generating a new rule on driving behavior characteristic inference.

Other features and aspects of the disclosed technology will become apparent from the following detailed description, taken in conjunction with the accompanying drawings, which illustrate, by way of example, the features in accordance with applications of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various applications, is described in detail with reference to the following figures. The figures are provided for purposes of illustration only and merely depict typical or example applications.

FIG. 1 illustrates an example computing system for refining predictive driving actions, according to example applications described in the present disclosure.

FIG. 2 illustrates an example vehicle with which applications of the disclosed technology may be implemented.

FIG. 3 illustrates an example system for refining predictive driving actions, according to example applications described in the present disclosure.

FIG. 4 illustrates an example process for refining predictive driving actions, according to example applications described in the present disclosure.

FIG. 5 illustrates an example system for refining predictive driving actions, according to an example application described in the present disclosure.

FIG. 6 illustrates an example system for refining predictive driving actions, according to an example application described in the present disclosure.

FIG. 7 illustrates an example computing component that includes one or more hardware processors and machine-readable storage media storing a set of machine-readable/machine-executable instructions that, when executed, cause the one or more hardware processors to perform an illustrative method for refining predictive driving actions, according to example applications described in the present disclosure.

FIG. 8 illustrates a block diagram of an example computing component that may be used to implement various features of embodiments described in the present disclosure.

The figures are not exhaustive and do not limit the present disclosure to the precise form disclosed.

### DETAILED DESCRIPTION

Vehicles may be used as a means of transportation for individual, commercial, government, military and other purposes. Vehicles may include automobiles, trucks, motorcycles, bicycles, scooters, mopeds, recreational vehicles and other like on-or off-road vehicles. Vehicles may further include autonomous, semi-autonomous and manual vehicles. With vehicles being a primary source of transportation of the public, it is important for vehicles to be operated in safe and responsible manners to ensure the safety of the public. As vehicles are being operated on roads, current programs have difficulty with accurately and efficiently detecting unsafe driving behaviors of vehicles to accurately and efficiently predict subsequent actions of the unsafely driven vehicles.

Aspects of the technology disclosed herein may provide systems and methods configured to detect unsafe driving behaviors and refine predictive driving actions. An ego vehicle may be traveling on a road. The ego vehicle may include, for example, an automobile, truck, motorcycle, bicycle, scooter, moped, recreational vehicle and other like on-or off-road vehicles. The ego vehicle may include, for example, an autonomous, semi-autonomous or manually operated vehicle. The ego vehicle may include one or more sensors that may be used to collect data of the driving behavior of the ego vehicle itself and the driving behavior of each of one or more other vehicles being operated in the vicinity of the ego vehicle. Each of the one or more other vehicles may themselves include one or more sensors that may be used to collect data of the driving behavior of itself and the driving behavior of each of the other vehicles, including the ego vehicle. Other sensors of roads, infrastructure elements, etc., may also be used and may collect driving data on the ego vehicle and each of the other vehicles as well as data on other factors such as the environment, road conditions, etc. Many variations are possible.

The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received by at least one sensor. Any vehicle, including the ego vehicle, may be monitored while traveling on a road to obtain driving data of the respective vehicle. One or more sensors may be used to collect the driving data of a vehicle, such as, for example, the ego vehicle. The driving data of a vehicle, including the ego vehicle, collected from multiple sensors may be combined to provide a collective and complete driving data of the respective vehicle. Driving data of the ego vehicle may be collected by one or more sensors of the ego vehicle, one or more sensors of one or more other vehicles, and one or more sensors of the road, such as, for example, road cameras, road sensors, etc.

The driving data of the ego vehicle that is collected and received may include information of the driving behavior of the ego vehicle. The information of the driving behavior of the ego vehicle may include information on one or more driving actions performed by the ego vehicle, including, for example, the speed, movements (or lack of movement), location, and direction of travel of the ego vehicle. The driving data of the ego vehicle may include an identity of a driver of the ego vehicle. The information of the driving behavior may be associated with the identity of the driver.

The driving data of the driving behavior of the ego vehicle may be used to infer characteristics of the driving behavior. The driving data of other vehicles may be used to infer characteristics of the driving behavior of the ego vehicle. Characteristics of the driving behavior of the ego vehicle may include one or more types of actions performed by the ego vehicle, a degree of repetition of each type of action, a motion pattern of the driving behavior, a period of the motion pattern of the driving behavior, and a degree of influence caused by the driving behavior of the ego vehicle to other vehicles. Types of actions that may be performed by the ego vehicle may include nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, lack of headlights, driving a speed limit, driving with the flow of traffic, proper signaling, and driving within a lane. A degree of repetition of a type of action may include an amount and frequency of each type of action being performed. A motion pattern may include a sequence of actions being performed. A sequence of actions may include a sequence of the same type of action or a sequence of a combination of different types of actions. A period of a motion pattern may include an amount of time the motion pattern is being performed. A degree of influence may include an amount and frequency of the influence that the driving behavior of a vehicle has on other vehicles.

After characteristics of the driving behavior have been inferred, one or more prediction models may be selected based on the characteristics. Some characteristics may be potential indicators of unsafe driving of a vehicle. A potential indicator of unsafe driving may include one or more characteristics of the driving behavior, including, for example, particular types of actions, at least a minimum amount of degree of repetition of a type of action, particular types of motion patterns, at least a minimum amount of a period of a motion pattern, and at least a minimum amount of degree of influence on other vehicles. Types of actions that may be a potential indicator of unsafe driving may include, for example, nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, and lack of headlights.

A minimum amount of degree of repetition of a type of action may be a potential indicator of unsafe driving when, for example, the type of action is performed for at least a particular number of times within a particular period of time. The minimum amount of degree of repetition of a type of action may be dependent on the type of action. For example, a minimum amount of degree of repetition for weaving may be more than X weaves by a vehicle in a span of Y seconds. The minimum amount of degree of repetition for a type of action may be predetermined. The minimum amount of degree of repetition for a type of action may be adjusted according to data received of historic driving behavior of vehicles, data received from the road traffic network, data received from the road conditions network, etc. Many variations are possible.

A motion pattern that may be a potential indicator of unsafe driving when a sequence of actions performed includes, for example, at least two actions, whether the same or different types of actions, that are potential indicators of unsafe driving. A period of a motion pattern may be a potential indicator of unsafe driving when the motion pattern includes one or more types of actions performed within a particular duration of time, such as, for example, one minute, 2 minutes, 5 minutes, 30 seconds, etc. The period of a motion pattern considered as a potential indicator of unsafe driving may be dependent on one or more factors, such as, for example, the time of day, traffic, road conditions, weather, number of surrounding vehicles the ego vehicle, etc. Road conditions may include, for example, damages to the road, hazardous features on the road (i.e., obstructions), and attributes and characteristics of the road (i.e., the color, size, number of lanes, shape, etc.). An obstruction may include, for example, a pothole, crack, tire marking, faded road marking, debris, object, occlusion, road reflection, flooding, icy surface, oil leak, uneven pavement, erosion and raveling. The data of road conditions obtained may be analyzed by the computing component 110 and used as a factor to determine a period of motion pattern to be considered as a potential indicator of unsafe driving.

A degree of influence may be a potential indicator of unsafe driving when actions performed by an ego vehicle may have a negative effect on one or more other vehicles. A negative effect may include a reaction made by another vehicle or driver of another vehicle from the action performed by the ego vehicle. The reaction action may be an action made in response to bad or unsafe driving. For example, a reaction may include yelling, hand gestures, and accident preventative driving (i.e., changing lanes, slowing down, and speeding up). Many variations are possible.

If any inferred characteristics of the driving behavior is determined to be a potential indicator of unsafe driving, one or more predictive models may be selected based on the inferred characteristic(s). A predictive model may be a ML model that is used to analyze characteristics of driving behaviors to predict next driving actions of a vehicle. A predictive model may include a reckless behavior prediction model, aggressive behavior prediction model and distracted behavior prediction model. Each predictive model may represent a different category of unsafe driving behaviors. Based on the one or more potential indicators of unsafe driving determined for an ego vehicle, one or more prediction models may be selected. Some potential indicators of unsafe driving may represent more than one category of unsafe driving behaviors. Depending on the combination of one or more potential indicators of unsafe driving determined for an ego vehicle, the most relevant predictive model(s) may be selected.

The reckless behavior prediction model may be selected when the determined potential indicators are indicative of the ego vehicle being driven in a reckless manner. The reckless behavior prediction model may be selected when the determined potential indicators include, for example, a high degree of repetition of swerving with a motion pattern of swerving and speeding for a duration of over one minute, with a high degree of influence on at least five other vehicles. Another example of determined potential indicators that may lead to the reckless behavior prediction model being selected may include a high degree of repetition of nudging with a motion pattern of nudging, accelerations, decelerations, tailgating, and lack of headlights for a duration of over 30 seconds, with at least a medium degree of influence on at least seven other vehicles. Many variations are possible.

The aggressive behavior prediction model may be selected when the determined potential indicators are indicative of the ego vehicle being driven in an aggressive manner. The aggressive behavior prediction model may be selected when the determined potential indicators include, for example, a high degree of repetition of accelerations, decelerations, and nudging within a motion pattern for a duration of over 20 seconds that has at least a medium degree of influence on at least eight other vehicles. Another example of determined potential indicators that may lead to the aggressive behavior prediction model being selected may include a medium degree of repetition of speeding, weaving and tailgating within a motion pattern for a duration of over 30 seconds that has a high degree of influence on at least four other vehicles. Many variations are possible.

The distracted behavior prediction model may be selected when the determined potential indicators is indicative of the ego vehicle being driven in a distracted manner. The distracted behavior prediction model may be selected when the determined potential indicators include, for example, a medium degree of repetition of lane drifting and failure to signal within a motion pattern for a duration of over 40 seconds that has at least a medium degree of influence on at least five other vehicles. Another example of determined potential indicators that may lead to the distracted behavior prediction model being selected may include a low degree of repetition of weaving, failure to signal, tailgating, nudging, driving slow and delayed stopping within a motion pattern for a duration of over 30 seconds that has at least a medium degree of influence on at least six other vehicles. Many variations are possible.

There may be a combination of potential indicators of unsafe driving that could represent more than one category of unsafe driving behavior. When more than one category of unsafe driving behavior may be represented by the combination of potential indicators, each predictive model of each respective represented category of unsafe driving may be selected. Potential combinations of predictive models that may be selected may include, for example, the reckless behavior prediction model and aggressive behavior prediction model, the aggressive behavior prediction model and the distracted behavior prediction model, etc. Many variations are possible.

The selected predictive model(s) may be used to predict the next driving data of the ego vehicle. The next driving data may include next driving actions that the ego vehicle may perform. The next driving data of the ego vehicle may be predicted according to one or more algorithms of the predictive model(s) based on the potential indicator characteristics of unsafe driving that the ego vehicle was determined to have performed and the environmental data of the ego vehicle. Environmental data of the ego vehicle may be obtained from one or more sensors of the ego vehicle, other vehicles, road, infrastructures, etc. Many variations are possible.

Each of the predictive models may include one or more algorithms used to determine the predicted next driving data based on the environmental data of the ego vehicle and the determined potential indicator characteristics of unsafe driving. The one or more algorithms may be pre-stored. The one or more algorithms may include a plurality of equations and methods to determine the predicted next driving data. In other applications, each of the predictive models may include ML and/or AI logic. ML and/or AI logic may be used to determine the predicted next driving data. The ML and/or AI logic may use data from previous sessions, whether on the same ego vehicle or other vehicles, and stored data to more quickly and efficiently determine the predicted next driving data to be performed by the ego vehicle, including, for example, types of actions predicted to be performed and a path of travel to be taken.

Upon a determination of the predicted next driving data of the ego vehicle, one or more other vehicles in a nearby vicinity of the ego vehicle may be notified of the ego vehicle performing potentially unsafe driving behaviors. The notification may include a location of the ego vehicle in relation to the respective vehicle being notified. Each vehicle being notified may also receive information of the predicted next driving actions of the ego vehicle. The notification may include suggestive actions for the respective vehicle to perform to navigate away from the ego vehicle based on the predicted next driving actions of the ego vehicle. The notification may include a message that may be displayed on a screen of the respective vehicle receiving the notification. The notification to another vehicle may assist the other vehicle with avoiding the ego vehicle.

The driving behavior of the ego vehicle may be monitored to determine if the actual next driving actions performed by the ego vehicle match the predicted next driving actions determined by the one or more predictive models. While monitoring the driving behavior of the ego vehicle, the actual next driving actions performed by the subject vehicle may be identified. The identified actual next driving actions of the ego vehicle may be compared with the predicted next driving actions.

It may be determined if the actual next driving actions performed by the ego vehicle match the predicted next driving actions. If the actual next driving actions match the predicted next driving actions of the ego vehicle, then it can be determined that the potential indicator characteristics of unsafe driving, the predictive model(s), and predictive analysis of next driving actions of a vehicle are accurate and may be reenforced to improve in the efficiency in determining potential indicator characteristics of unsafe driving and performing predictive analysis of next driving actions of a vehicle. If the actual next driving actions do not match the predicted next driving actions of the ego vehicle, then it can be determined that the potential indicator characteristics of unsafe driving, the predictive model(s), and/or predictive analysis of next driving actions of a vehicle need to be refined to improve in the accuracy and efficiency in determining potential indicator characteristics of unsafe driving and performing predictive analysis of next driving actions of a vehicle.

If the actual next driving actions performed by the ego vehicle are determined to not match the predicted next driving actions, then it may be determined that at least one of the following needs to be updated and refined: (i) the potential indicator characteristics of unsafe driving, (ii) the predictive model(s) selected based on the potential indicator characteristics of unsafe driving, and (iii) the algorithm(s) in the predictive model(s) and logic used to perform predictive analysis of the next driving data. Refining at least one of the potential indicators, predictive model(s) selection, and predictive model(s) algorithm(s) and logic may improve the accuracy and efficiency in detecting and characterizing driving behaviors of vehicles to determine unsafe drivers on the road.

It should be noted that the terms “accurate,” “accurately,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

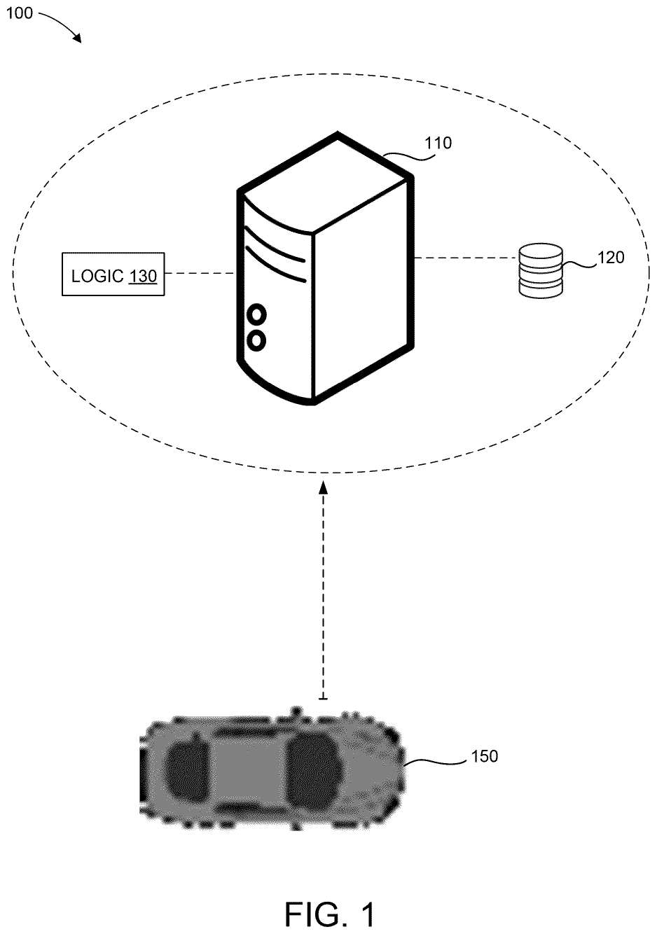

FIG. 1 illustrates an example of a computing system 100 which may be internal or otherwise associated within a vehicle 150. In some embodiments, the computing system 100 may be a machine learning (ML) pipeline and model, and use ML algorithms. In some examples, vehicle 150 may include an autonomous, semi-autonomous or manual vehicle, with which applications of the disclosed technology may be implemented. In some examples, vehicle 150 may include an automobile, truck, motorcycle, bicycle, scooter, moped, recreational vehicle and other like on-or off-road vehicles, that may include an autonomous, semi-autonomous and manual operation. In some examples, the vehicle 150 may include a computing device, such as a desktop computer, a laptop, a mobile phone, a tablet device, an Internet of Things (IoT) device, etc. The vehicle 150 may input data into computing component 110. The computing component 110 may perform one or more available operations on the input data to generate outputs, such as detecting unsafe driving behaviors and predicting driving actions. The vehicle 150 may further display the outputs on a Graphical User Interface (GUI). The GUI may be on the vehicle 150 and may display the outputs as a two-dimensional (2D) and three-dimensional (3D) layout and map showing the various outputs generated by algorithms, such as ML algorithms, based on various input data, such as sensor data of road conditions, environmental conditions, lane markers, traffic, speed of vehicles, direction of vehicles, obstructions, and objects from vehicles and roads.

The computing system 110 in the illustrated example may include one or more processors and logic 130 that implements instructions to carry out the functions of the computing component 110, for example, receiving driving data of a vehicle 150; analyzing the driving data to determine a driving behavior of the vehicle 150; inferring, based on the driving behavior, a characteristic of the driving behavior; electing a prediction model according to the characteristic; determining, using the prediction model, a predictive action of the vehicle 150 according to environmental data of the vehicle 150; monitoring the vehicle 150 to determine a next action of the vehicle 150; analyzing the next action to determine whether the next action matches the predictive action; and refining the prediction model according to the analysis of the next action. The computing component 110 may store, in a database 120, details regarding scenarios or conditions in which some algorithms, image datasets, and assessments are performed and used to detect unsafe driving behaviors and predict driving actions. Some of the scenarios or conditions will be illustrated in the subsequent figures.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with vehicle 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model, such as, for example, predictive models for driving behaviors detection and predictive analysis. According to implementations of the disclosed technology, the ML algorithm comprises, among other aspects, algorithms implementing a Gaussian process and the like. The ML algorithms disclosed herein may be supervised and/or unsupervised depending on the implementation. The ML algorithms may emulate the observed characteristics and components of roads, vehicles and drivers to better evaluate driving behaviors of vehicles, detect unsafe driving behaviors, predict driving actions, and refine predictive analysis of driving actions to accurately detect and characterize driving behaviors of vehicles.

Although one example computing system 110 is illustrated in FIG. 1, in various embodiments multiple computing systems 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components.

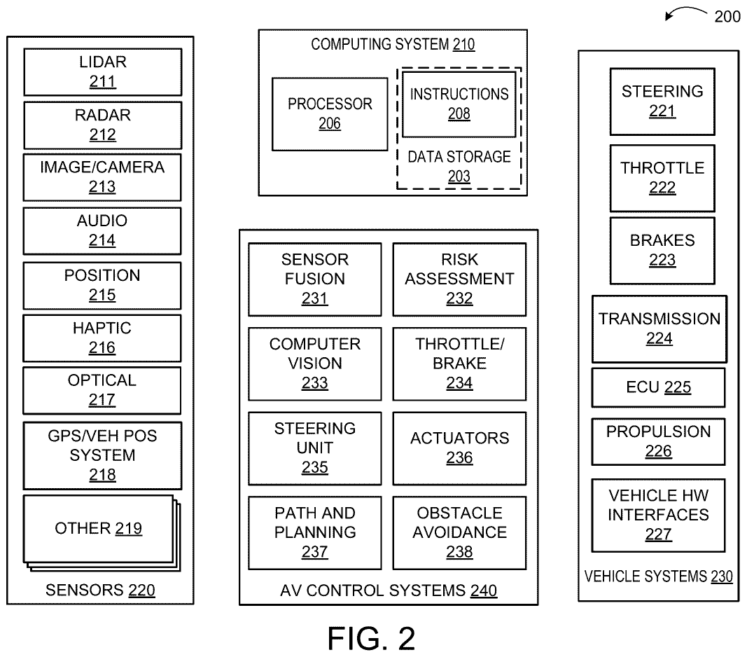

FIG. 2 illustrates an example connected vehicle 200, such as an autonomous, semi-autonomous or manual vehicle, with which applications of the disclosed technology may be implemented. As described herein, vehicle 200 can refer to a vehicle, such as an automobile, truck, motorcycle, bicycle, scooter, moped, recreational vehicle and other like on-or off-road vehicles, that may include an autonomous, semi-autonomous and manual operation. The vehicle 200 may include components, such as a computing system 210, sensors 220, vehicle systems 230, and AV control systems 240. Either of the computing system 210, sensors 220, vehicle systems 230, and AV control systems 240 can be part of an automated vehicle system/advanced driver assistance system (ADAS). ADAS can provide navigation control signals (e.g., control signals to actuate the vehicle and operate one or more vehicle systems 240 as shown in FIG. 2) for the vehicle to navigate a variety of situations. As used herein, ADAS can be an autonomous vehicle control system adapted for any level of vehicle control and driving autonomy. For example, the ADAS can be adapted for level 1, level 2, level 3, level 4, and level 5 autonomy (according to SAE standard). ADAS can allow for control mode blending (i.e., blending of autonomous and assisted control modes with human driver control). ADAS can correspond to a real-time machine perception system for vehicle actuation in a multi-vehicle environment. Vehicle 200 may include a greater or fewer quantity of systems and subsystems, and each could include multiple elements. Accordingly, one or more of the functions of the technology disclosed herein may be divided into additional functional or physical components, or combined into fewer functional or physical components. Additionally, although the systems and subsystems illustrated in FIG. 2 are shown as being partitioned in a particular way, the functions of vehicle 200 can be partitioned in other ways. For example, various vehicle systems and subsystems can be combined in different ways to share functionality.

Sensors 220 may include a plurality of different sensors to gather data regarding vehicle 200, its operator, its operation and its surrounding environment. Although various sensors are shown, it can be understood that systems and methods for detecting unsafe driving behaviors and refining predictive driving actions may not require many sensors. It can also be understood that system and methods described herein can be augmented by sensors off the vehicle 200. In this example, sensors 220 include light detection and ranging (LiDAR) sensor 211, radar sensor 212, image sensors 213 (i.e., a camera), audio sensors 214, position sensor 215, haptic sensor 216, optical sensor 217, a Global Positioning System (GPS) or other vehicle positioning system 218, and other like distance measurement and environment sensing sensors 219. One or more of the sensors 220 may gather data, such as road conditions data, and send that data to the vehicle ECU or other processing unit. Sensors 220 (and other vehicle components) may be duplicated for redundancy.

Distance measuring sensors such as LiDAR sensor 211, radar sensor 212, IR sensors and other like sensors can be used to gather data to measure distances and closing rates to various external objects such as other vehicles, roads, traffic signs, pedestrians, light poles and other objects. Image sensors 213 can include one or more cameras or other image sensors to capture images of the environment around the vehicle, such as road surfaces, as well as internal to the vehicle. Information from image sensors 213 (e.g., camera) can be used to determine information about the environment surrounding the vehicle 200 including, for example, information regarding road surfaces and other objects surrounding vehicle 200. For example, image sensors 213 may be able to recognize specific vehicles (e.g. color, vehicle type), landmarks or other features (including, e.g., street signs, traffic lights, etc.), slope of the road, lines on the road, damages and other potentially hazardous conditions to the road, curbs, objects to be avoided (e.g., other vehicles, pedestrians, bicyclists, etc.) and other landmarks or features. Information from image sensors 213 can be used in conjunction with other information such as map data, or information from positioning system 218 to determine, refine, or verify vehicle (ego vehicle or another vehicle) location as well as detect obstructions and vehicle driving behaviors.

Vehicle positioning system 218 (e.g., GPS or other positioning system) can be used to gather position information about a current location of the vehicle as well as other positioning or navigation information, such as the positioning information about a current location and direction of movement of the vehicle according to a particular road condition.

Other sensors 219 may be provided as well. Other sensors 219 can include vehicle acceleration sensors, vehicle speed sensors, wheelspin sensors (e.g., one for each wheel), a tire pressure monitoring sensor (e.g., one for each tire), vehicle clearance sensors, left-right and front-rear slip ratio sensors, and environmental sensors (e.g. to detect weather, traction conditions, or other environmental conditions). Other sensors 219 can be further included for a given implementation of ADAS. Various sensors 220, such as other sensors 219, may be used to provide input to computing system 210 and other systems of vehicle 200 so that the systems have information useful to detect and verify vehicles and their driving behaviors.

AV control systems 240 may include a plurality of different systems/subsystems to control operation of vehicle 200. In this example, AV control systems 240 can include, autonomous driving module (not shown), sensor fusion module 231, risk assessment module 232, computer vision module 233, throttle and brake control unit 234, steering unit 235, actuator(s) 236, path and planning module 237, and obstacle avoidance module 238. Sensor fusion module 231 can be included to evaluate data from a plurality of sensors, including sensors 220. Sensor fusion module 231 may use computing system 210 or its own computing system to execute algorithms to assess inputs from the various sensors.

Computer vision module 233 may be included to process image data (e.g., image data captured from image sensors 213, or other image data) to evaluate the environment within or surrounding the vehicle. For example, algorithms operating as part of computer vision module 233 can evaluate still or moving images to determine features and landmarks (e.g., road pavements, lines of the road, damages and other potentially hazardous conditions on the road, road signs, traffic lights, lane markings and other road boundaries, etc.), obstacles (e.g., pedestrians, bicyclists, other vehicles, other obstructions in the path of the subject vehicle) and other objects. The system can include video tracking and other algorithms to recognize objects such as the foregoing, estimate their speed, map the surroundings, and so on. Computer vision module 233 may be able to model the road traffic vehicle network, predict incoming hazards and obstacles, predict road hazard, and determine one or more contributing factors to identifying obstructions. Computer vision module 233 may be able to perform depth estimation, image/video segmentation, camera localization, and object classification according to various classification techniques (including by applied neural networks).

Throttle and brake control unit 234 can be used to control actuation of throttle and braking mechanisms of the vehicle to accelerate, slow down, stop or otherwise adjust the speed of the vehicle. For example, the throttle unit can control the operating speed of the engine or motor used to provide motive power for the vehicle. Likewise, the brake unit can be used to actuate brakes (e.g., disk, drum, etc.) or engage regenerative braking (e.g., such as in a hybrid or electric vehicle) to slow or stop the vehicle.

Steering unit 235 may include any of a number of different mechanisms to control or alter the heading of the vehicle. For example, steering unit 235 may include the appropriate control mechanisms to adjust the orientation of the front or rear wheels of the vehicle to accomplish changes in direction of the vehicle during operation. Electronic, hydraulic, mechanical or other steering mechanisms may be controlled by steering unit 235.

Path and planning module 237 may be included to compute a desired path for vehicle 200 based on input from various other sensors and systems. For example, path and planning module 237 can use information from positioning system 218, sensor fusion module 231, computer vision module 233, obstacle avoidance module 238 (described below) and other systems (e.g., AV control systems 240, sensors 220, and vehicle systems 230) to determine a safe path to navigate the vehicle along a segment of a desired route. Path and planning module 237 may also be configured to dynamically update the vehicle path as real-time information is received from sensors 220 and other control systems 240.

Obstacle avoidance module 238 can be included to determine control inputs necessary to avoid obstacles, obstructions, and other vehicles detected by sensors 220 or AV control systems 240. Obstacle avoidance module 238 can work in conjunction with path and planning module 237 to determine an appropriate path to avoid and navigate around obstacles and obstructions.

Path and planning module 237 (either alone or in conjunction with one or more other module of AV Control system 240, such as obstacle avoidance module 238, computer vision module 233, and sensor fusion module 231) may also be configured to perform and coordinate one or more vehicle maneuvers. Example vehicle maneuvers can include at least one of a path tracking, stabilization and collision avoidance maneuver. With connected vehicles, such as vehicles selected to verify obstructions, vehicle maneuvers can be performed at least partially cooperatively between the connected vehicles to gather a sufficient amount of data of the obstruction. A sufficient amount of data of an obstruction may include collecting data of the obstruction at various angles and perspectives. Each different type of obstruction may warrant a different amount of data to be collected and analyzed to make the needed determinations to verify the obstruction. For example, data needed to verify a small obstruction, like a small pothole, may be minimal as the connected vehicles collecting verification data of the small pothole obstruction may only need to collect data of missing asphalt on the road. The data needed to verify a larger obstruction, like a downed traffic light, may be much more extensive as the connected vehicles collecting verification data of the downed traffic light obstruction may need to collect data of the portion of the roadway blocked by the downed traffic light, electrical issues present on the roadway, disrupted traffic flow caused by the downed traffic light, including, for example, any other vehicles or objects blocking traffic due to the downed traffic light, additional obstructions on the road caused by the downed traffic light, including, for example, cracks, potholes, debris, etc., and so on. Hence, those of ordinary skill in the art will understand what sufficient means in the context of collecting a sufficient amount of data to verify an obstruction.

Vehicle systems 230 may include a plurality of different systems/subsystems to control operation of vehicle 200. In this example, vehicle systems 230 include steering system 221, throttle system 222, brakes 223, transmission 224, electronic control unit (ECU) 225, propulsion system 226 and vehicle hardware interfaces 227. The vehicle systems 230 may be controlled by AV control systems 240 in autonomous, semi-autonomous or manual mode of vehicle 200. For example, in autonomous or semi-autonomous mode, AV control systems 240, alone or in conjunction with other systems, can control vehicle systems 230 to operate the vehicle in a fully or semi-autonomous fashion. When control is assumed, computing system 210 and AV control system 240 can provide vehicle control systems to vehicle hardware interfaces for controlled systems such as steering angle 221, throttle 222, brakes 223, or other hardware interfaces 227, such as traction force, turn signals, horn, lights, etc. This may also include an assist mode in which the vehicle takes over partial control or activates ADAS controls (e.g., AC control systems 240) to assist the driver with vehicle operation.

Computing system 210 in the illustrated example includes a processor 206, and memory 203. Some or all of the functions of vehicle 200 may be controlled by computing system 210. Processor 206 can include one or more GPUs, CPUs, microprocessors or any other suitable processing system. Processor 206 may include one or more single core or multicore processors. Processor 206 executes instructions 208 stored in a non-transitory computer readable medium, such as memory 203.

Memory 203 may contain instructions (e.g., program logic) executable by processor 206 to execute various functions of vehicle 200, including those of vehicle systems and subsystems. Memory 203 may contain additional instructions as well, including instructions to transmit data to, receive data from, interact with, and control one or more of the sensors 220, AV control systems 240 and vehicle systems 230. In addition to the instructions, memory 203 may store data and other information used by the vehicle and its systems and subsystems for operation, including operation of vehicle 200 in the autonomous, semi-autonomous or manual modes. For example, memory 203 can include data that has been communicated to the ego vehicle (e.g. via V2V communication), mapping data, a model of the current or predicted road traffic vehicle network, vehicle dynamics data, computer vision recognition data, and other data which can be useful for the execution of one or more vehicle maneuvers, for example by one or more modules of the AV control systems 240.

Although one computing system 210 is illustrated in FIG. 2, in various applications multiple computing systems 210 can be included. Additionally, one or more systems and subsystems of vehicle 200 can include its own dedicated or shared computing system 210, or a variant thereof. Accordingly, although computing system 210 is illustrated as a discrete computing system, this is for ease of illustration only, and computing system 210 can be distributed among various vehicle systems or components.

Vehicle 200 may also include a (wireless or wired) communication system (not illustrated) to communicate with other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow vehicle 200 to receive information from other objects including, for example, map data, data regarding infrastructure elements, data regarding operation and intention of surrounding vehicles, and so on. A wireless communication system may allow vehicle 200 to receive updates to data that can be used to execute one or more vehicle control modes, and vehicle control algorithms as discussed herein. Wireless communication system may also allow vehicle 200 to transmit information to other objects and receive information from other objects (such as other vehicles, user devices, or infrastructure). In some applications, one or more communication protocol or dictionaries can be used, such as the SAE J2935 V2X Communications Message Set Dictionary. In some applications, the communication system may be useful in retrieving and sending one or more data useful in detecting unsafe driving behaviors and refining predictive driving actions, as disclosed herein.

Communication system can be configured to receive data and other information from sensors 220 that is used in determining whether and to what extent control mode blending should be activated. Additionally, communication system can be used to send an activation signal or other activation information to various vehicle systems 230 and AV control systems 240 as part of controlling the vehicle. For example, communication system can be used to send signals to one or more of the vehicle actuators 236 to control parameters, for example, maximum steering angle, throttle response, vehicle braking, torque vectoring, and so on.

In some applications, computing functions for various applications disclosed herein may be performed entirely on computing system 210, distributed among two or more computing systems 210 of vehicle 200, performed on a cloud-based platform, performed on an edge-based platform, or performed on a combination of the foregoing.

Path and planning module 237 can allow for executing one or more vehicle control mode(s), and vehicle control algorithms in accordance with various implementations of the systems and methods disclosed herein.

In operation, path and planning module 237 (e.g., by a driver intent estimation module, not shown) can receive information regarding human control input used to operate the vehicle. As described above, information from sensors 220, actuators 236 and other systems can be used to determine the type and level of human control input. Path and planning module 237 can use this information to predict driver action. Path and planning module 237 can use this information to generate a predicted path and model the road traffic vehicle network. This may be useful in evaluating road conditions, and determining and verifying obstructions. As also described above, information from sensors, and other systems can be used to evaluate road conditions, and determine and verify obstructions. Eye state tracking, attention tracking, or intoxication level tracking, for example, can be used to determine vehicle movement patterns according to inherent human behavior. It can be understood that the driver state can contribute to verifying obstructions as disclosed herein. Driver state can be provided to a risk assessment module 232 to determine the level of risk associated with a vehicle operation, and detecting unsafe driving behaviors and refining predictive driving actions. Although not illustrated in FIG. 2, where the assessed risk contributes to determining vehicle movement patterns according to inherent human behaviors, a verification strategy may be generated and provided to vehicle 200 to verify obstructions. Aspects of detecting unsafe driving behaviors and refining predictive driving actions will be disclosed with reference to subsequent figures.

Path and planning module 237 can receive state information such as, for example from visibility maps, traffic and weather information, hazard maps, and local map views. Information from a navigation system can also provide a mission plan including maps and routing to path and planning module 237.

The path and planning module 237 (e.g., by a driver intent estimation module, not shown) can receive this information and predict behavior characteristics within a future time horizon. This information can be used by path and planning module 237 for executing one or more planning decisions. Planning decisions can be based on one or more policy (such as defensive driving policy). Planning decisions can be based on one or more level of autonomy, connected vehicle actions, one or more policy (such as defensive driving policy, cooperative driving policy, such as swarm or platoon formation, leader following, etc.). Path and planning module 237 can generate an expected model for the road traffic hazards and assist in creating a predicted traffic hazard level and verification strategy for vehicles to implement.

Path and planning module 237 can receive risk information from risk assessment module 232. Path and planning module 237 can receive vehicle capability and capacity information from one or more vehicle systems 230. Vehicle capability can be assessed, for example, by receiving information from vehicle hardware interfaces 227 to determine vehicle capabilities and identify a reachable set model. Path and planning module 237 can receive surrounding environment information (e.g., from computer vision module 233, and obstacle avoidance module 238). Path and planning module 237 can apply risk information and vehicle capability and capacity information to trajectory information (e.g., based on a planned trajectory and driver intent) to determine a safe or optimized trajectory for the vehicle given the drivers intent, policies (e.g. safety or vehicle cooperation policies), communicated information, given one or more obstacles in the surrounding environment, and road conditions. This trajectory information can be provided to controller (e.g., ECU 225) to provide partial or full vehicle control in the event of a risk level above threshold. A signal from risk assessment module 232 can be used generate countermeasures described herein. A signal from risk assessment module 232 can trigger ECU 225 or another AV control system 240 to take over partial or full control of the vehicle.

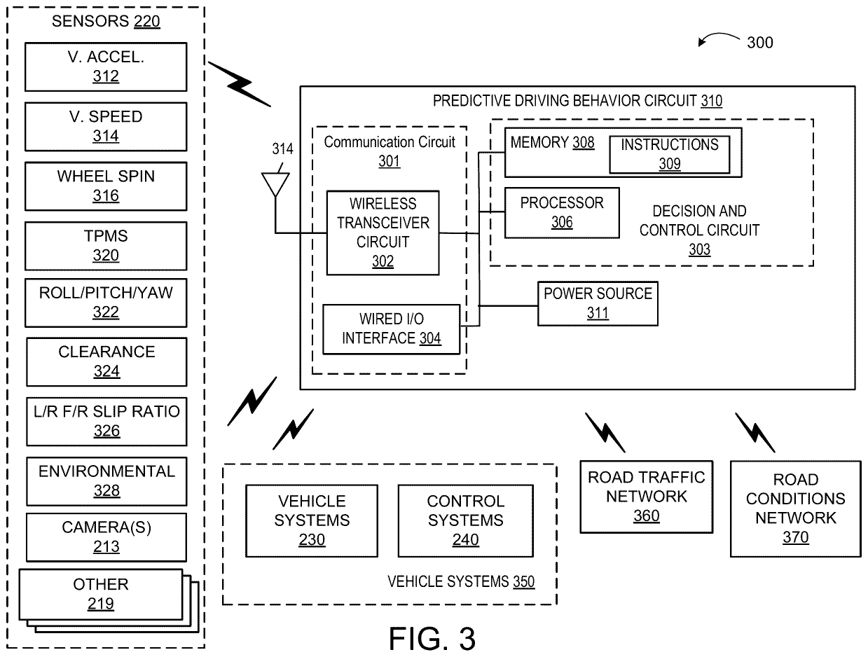

FIG. 3 illustrates an example architecture for detecting unsafe driving behaviors and refining predictive driving actions described herein. Referring now to FIG. 3, in this example, a predictive driving behavior system 300 includes a predictive driving behavior circuit 310, a plurality of sensors 220, and a plurality of vehicle systems 350. Also included are various elements of road traffic network 360 and road conditions network 370 with which the predictive driving behavior system 300 can communicate. It can be understood that a road traffic network 360 can include various elements that are navigating and important in navigating a road traffic network, such as vehicles, pedestrians (with or without connected devices that can include aspects of predictive driving behavior system 300 disclosed herein), or infrastructure (e.g., traffic signals, sensors, such as traffic cameras, databases, central servers, weather sensors, etc.). It can also be understood that a road conditions network 370 can include various elements that are navigating and important in navigating a road conditions network, such as roads, infrastructure (e.g., road sensors, such as road cameras, databases, central servers, weather sensors, etc.), weather, road constructions, or accidents. Other elements of the road traffic network 360 and road conditions network 370 can include connected elements at workplaces, or the home (such as vehicle chargers, connected devices, appliances, etc.).

Predictive driving behavior system 300 can be implemented as and include one or more components of the vehicle 200 shown in FIG. 2. Sensors 220, vehicle systems 350, elements of road traffic network 360, and elements of road conditions network 370 can communicate with the predictive driving behavior circuit 310 via a wired or wireless communication interface. As previously alluded to, elements of road traffic network 360 and road conditions network 370 can correspond to connected or unconnected devices, infrastructure (e.g., traffic signals, sensors, such as traffic cameras, weather sensors, road cameras, etc.), vehicles, pedestrians, obstacles, etc. that are in a broad or immediate vicinity of ego-vehicle (e.g., vehicle 200) or otherwise important to the navigation of the road traffic network or road condition network (such as remote infrastructure). Although sensors 220, vehicle systems 350, road traffic network 360, and road conditions network 370 are depicted as communicating with predictive driving behavior circuit 310, they can also communicate with each other, as well as with other vehicle systems 350 and directly with an element of the road traffic network 360 and road conditions network 370. Data as disclosed herein can be communicated to and from the predictive driving behavior circuit 310. For example, various infrastructure (example element of road traffic network 360 or road conditions network 370) can include one or more databases, such as vehicle crash data or weather data. This data can be communicated to the circuit 310, and such data can be updated based on outcomes for one or more maneuvers or navigation of the road traffic network, vehicle telematics, driver state (physical and mental), vehicle data from sensors 220 (e.g., tire pressure or brake status) from the vehicle. Similarly, traffic data, vehicle state data, time of travel, demographics data for drivers can be retrieved and updated. All of this data can be included in and contribute to predictive analytics (e.g., by machine learning) of accident possibility, and determinations of road conditions and poor, hazard road conditions. Similarly, models, circuits, and predictive analytics can be updated according to various outcomes.

Predictive driving behavior circuit 310 can evaluate vehicle driving behaviors, determine unsafe driving behaviors, predict driving actions, and refine predictive analysis of driving actions to accurately detect and characterize driving behaviors of vehicles as described herein. As will be described in more detail herein, the detection of unsafe driving behaviors can have one or more contributing factors. Various sensors 220, vehicle systems 350, road traffic network 360 elements, and road conditions network 370 elements may contribute to gathering data for evaluating vehicle driving behaviors, detecting unsafe driving behaviors, and predicting driving actions. For example, the predictive driving behavior circuit 310 can include at least one of an vehicle driving behavior detection and response circuit. The predictive driving behavior circuit 310 can be implemented as an ECU or as part of an ECU such as, for example electronic control unit 225. In other applications, predictive driving behavior circuit 310 can be implemented independently of the ECU, for example, as another vehicle system.

Predictive driving behavior circuit 310 can be configured to evaluate vehicle driving behaviors, detect unsafe driving behaviors, predict driving actions, refine predictive analysis, and appropriately respond. Predictive driving behavior circuit 310 may include a communication circuit 301 (including either or both of a wireless transceiver circuit 302 with an associated antenna 314 and wired input/output (I/O) interface 304 in this example), a decision and control circuit 303 (including a processor 306 and memory 308 in this example) and a power source 311 (which can include power supply). It is understood that the disclosed predictive driving behavior circuit 310 can be compatible with and support one or more standard or non-standard messaging protocols.

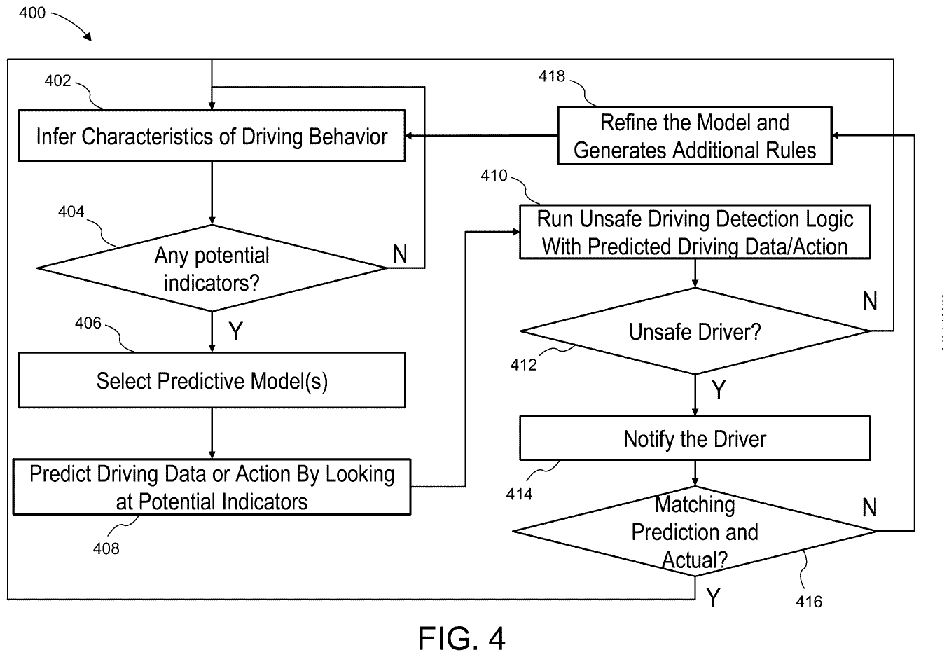

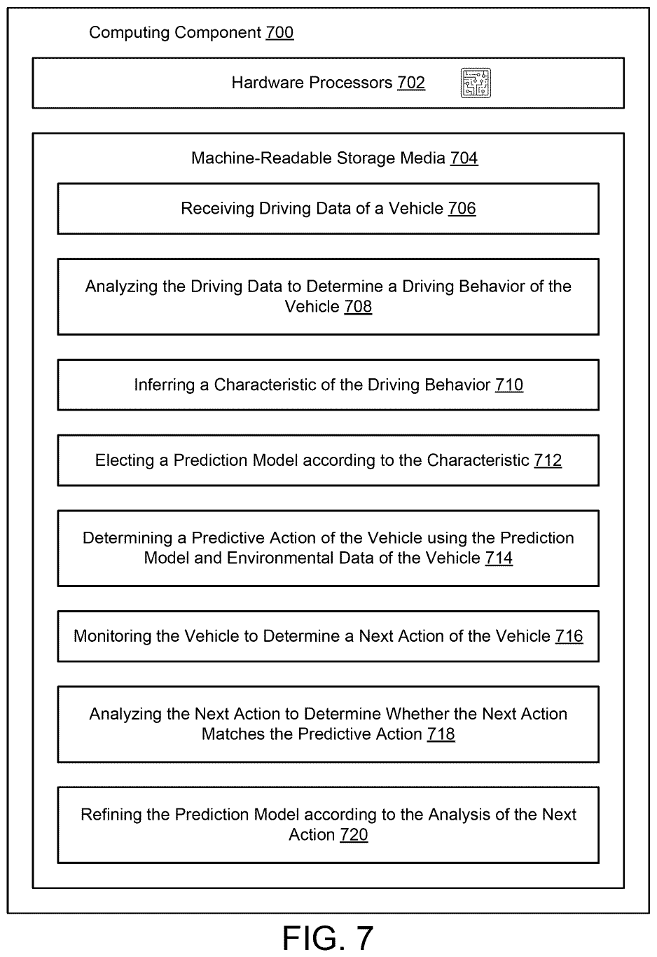

Components of predictive driving behavior circuit 310 are illustrated as communicating with each other via a data bus, although other communication in interfaces can be included. Decision and control circuit 303 can be configured to control one or more aspects of vehicle driving behavior detection and response. Decision and control circuit 303 can be configured to execute one or more steps described with reference to FIG. 4 and FIG. 7 (described below).

Processor 306 can include a GPU, CPU, microprocessor, or any other suitable processing system. The memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308 can be made up of one or more modules of one or more different types of memory, and may be configured to store data and other information as well as operational instructions 309 that may be used by the processor 306 to execute one or more functions of predictive driving behavior circuit 310. For example, data and other information can include vehicle driving data, such as a determined familiarity of the driver with driving and the vehicle. The data can also include values for signals of one or more sensors 220 useful in detecting unsafe driving behaviors and refining predictive driving actions. Operational instruction 309 can contain instructions for executing logical circuits, models, and methods as described herein.

Although the example of FIG. 3 is illustrated using processor and memory circuitry, as described below with reference to circuits disclosed herein, decision and control circuit 303 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a predictive driving behavior circuit 310. Components of decision and control circuit 303 can be distributed among two or more decision and control circuits 303, performed on other circuits described with respect to predictive driving behavior circuit 310, be performed on devices (such as cell phones) performed on a cloud-based platform (e.g. part of infrastructure), performed on distributed elements of the road traffic network 360, such as at multiple vehicles, user device, central servers, performed on an edge-based platform, and performed on a combination of the foregoing.

Communication circuit 301 may include either or both a wireless transceiver circuit 302 with an associated antenna 314 and a wired I/O interface 304 with an associated hardwired data port (not illustrated). As this example illustrates, communications with predictive driving behavior circuit 310 can include either or both wired and wireless communications circuits 301. Wireless transceiver circuit 302 can include a transmitter and a receiver (not shown), e.g., an vehicle driving behavior detection and verification broadcast mechanism, to allow wireless communications via any of a number of communication protocols such as, for example, WiFi (e.g. IEEE 802.11 standard), Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by predictive driving behavior 310 to/from other components of the vehicle, such as sensors 220, vehicle systems 350, infrastructure (e.g., servers cloud based systems), and other devices or elements of road traffic network 360. These RF signals can include information of almost any sort that is sent or received by vehicle.

Wired I/O interface 304 can include a transmitter and a receiver (not shown) for hardwired communications with other devices. For example, wired I/O interface 304 can provide a hardwired interface to other components, including sensors 220, vehicle systems 350. Wired I/O interface 304 can communicate with other devices using Ethernet or any of a number of other wired communication protocols whether standardized, proprietary, open, point-to-point, networked or otherwise.

Power source 311 such as one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, another vehicle battery, alternator, etc.), an energy harvester (e.g., solar cells, piezoelectric system, etc.), or it can include any other suitable power supply. It is understood power source 311 can be coupled to a power source of the vehicle, such as a battery and alternator. Power source 311 can be used to power the predictive driving behavior circuit 310.

Sensors 220 can include one or more of the previously mentioned sensors 220. Sensors 220 can include one or more sensors that may or not otherwise be included on a standard vehicle (e.g., vehicle 200) with which the predictive driving behavior circuit 310 is implemented. In the illustrated example, sensors 220 include vehicle acceleration sensors 312, vehicle speed sensors 314, wheelspin sensors 316 (e.g., one for each wheel), a tire pressure monitoring system (TPMS) 320, accelerometers such as a 3-axis accelerometer 322 to detect roll, pitch and yaw of the vehicle, vehicle clearance sensors 324, left-right and front-rear slip ratio sensors 326, environmental sensors 328 (e.g., to detect weather, salinity or other environmental conditions), and camera(s) 213 (e.g. front rear, side, top, bottom facing). Additional sensors 219 can also be included as may be appropriate for a given implementation predictive driving behavior system 300.

Vehicle systems 350 can include any of a number of different vehicle components or subsystems used to control or monitor various aspects of the vehicle and its performance. For example, it can include any or all of the aforementioned vehicle systems 240 and control systems 230 shown in FIG. 2. In this example, the vehicle systems 350 may include a GPS or other vehicle positioning system 218.

During operation, predictive driving behavior circuit 310 can receive information from various vehicle sensors 220, vehicle systems 350, road traffic network 360, and road conditions network 370 to detect unsafe driving behaviors and refine predictive driving actions. Also, the driver, owner, and operator of the vehicle may manually trigger one or more processes described herein for detecting unsafe driving behaviors and refining predictive driving actions. Communication circuit 301 can be used to transmit and receive information between the predictive driving behavior circuit 310, sensors 220 and vehicle systems 350. Also, sensors 220 and predictive driving behavior circuit 310 may communicate with vehicle systems 350 directly or indirectly (e.g., via communication circuit 301 or otherwise). Communication circuit 301 can be used to transmit and receive information between predictive driving behavior circuit 310, one or more other systems of a vehicle 200, but also other elements of a road traffic network 360 and road conditions network 370, such as vehicles, roads, devices (e.g., mobile phones), systems, networks (such as a communications network and central server), and infrastructure.

In various applications, communication circuit 301 can be configured to receive data and other information from sensors 220 and vehicle systems 350 that is used in detecting unsafe driving behaviors and refining predictive driving actions. As one example, when data is received from an element of road traffic network 360 or road conditions network 370 (such as from a driver's user device), communication circuit 301 can be used to send an activation signal and activation information to one or more vehicle systems 350 or sensors 220 for the vehicle to implement a verification strategy to detect unsafe driving behaviors and refine predictive driving actions. For example, it may be useful for vehicle systems 350 or sensors 220 to provide data useful in detecting unsafe driving behaviors and refining predictive driving actions. Alternatively, predictive driving behavior circuit 310 can be continuously receiving information from vehicle system 350, sensors 220, other vehicles, devices and infrastructure (e.g., those that are elements of road traffic network 360 or road conditions network 370). Further, upon detecting vehicle driving behavior, communication circuit 301 can send a signal to other components of the vehicle, infrastructure, or other elements of the road traffic network or road conditions network based on the detection of the vehicle driving behavior. For example, the communication circuit 301 can send a signal to a vehicle system 350 that indicates a control input for performing one or more predictive analysis of the vehicle driving behavior to determine whether a surrounding vehicle is performing unsafe driving behaviors. In some applications upon detecting an unsafe driving behavior of a surrounding vehicle, depending on the type of the unsafe driving behavior, the driver's control of the ego vehicle can be prohibited, and control of the ego vehicle can be offloaded to the ADAS. In more specific examples, upon detection of an unsafe driving behavior (e.g., by sensors 220, and vehicle system 350 or by elements of the road traffic network 360 or road conditions network 370), one or more signals can be sent to a vehicle system 350, so that an assist mode can be activated and the vehicle can control one or more of vehicle systems 240 (e.g., steering system 221, throttle system 222, brakes 223, transmission 224, ECU 225, propulsion system 226, suspension, and powertrain).

The examples of FIGS. 2 and 3 are provided for illustration purposes only as examples of vehicle 200 and predictive driving behavior system 300 with which applications of the disclosed technology may be implemented. One of ordinary skill in the art reading this description will understand how the disclosed applications can be implemented with vehicle platforms.

FIG. 4 illustrates an example process 400 that includes one or more steps that may be performed to detect unsafe driving behaviors and refine predictive driving actions. In some applications, the process 400 can be executed, for example by the computing component 110 of FIG. 1. In another application, the process 400 may be implemented as the computing component 110 of FIG. 1. In other applications, the process 400 may be implemented as, for example, the computing system 210 of FIG. 2 and the predictive driving behavior system 300 of FIG. 3. The process 400 may include a server. The process 400 may be implemented by one or more vehicles where the one or more vehicles may form a P2P or V2V network.

At step 402, the computing component 110 infers characteristics of driving behavior. An ego vehicle may be traveling on a road. The ego vehicle may include, for example, an automobile, truck, motorcycle, bicycle, scooter, moped, recreational vehicle and other like on-or off-road vehicles. The ego vehicle may include, for example, an autonomous, semi-autonomous and manual operation. The ego vehicle may include one or more sensors that may be used to collect data of the driving behavior of itself and the driving behavior of each of one or more other vehicles. Each of the one or more other vehicles may include one or more sensors that may be used to collect data of the driving behavior of itself and the driving behavior of each of the other vehicles, including the ego vehicle.

The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received by at least one sensor of a vehicle. The ego vehicle may be in a position on a road that is in an approximate area of a path of travel of a subject vehicle. The approximate area of a path of travel of the subject vehicle may include a position that is in front, behind, or on either side of the subject vehicle as the subject vehicle is traveling. The computing component 110 may use one or more sensors of a vehicle to collect the data of the driving behavior of a subject vehicle. The computing component 110 may combine data of the driving behavior of a subject vehicle collected by one or more sensors of the ego vehicle with data of the driving behavior of the subject vehicle collected by one or more sensors of one or more other vehicles and of the road, such as, for example, road cameras, road sensors, etc.

The data of the driving behavior of a subject vehicle may include information on one or more driving actions performed by the subject vehicle, including the speed, movements (or lack of movements), and direction of travel of the subject vehicle. The data of the driving behavior of the subject vehicle may include an identity of a driver of the subject vehicle. The data of the driving behavior of the subject vehicle may be used by the computing component 110 to infer characteristics of the driving behavior. The data of the driving behavior of one or more other vehicles may be used to infer characteristics of the driving behavior of the subject vehicle. Characteristics of the driving behavior of the subject vehicle may include one or more types of actions performed by the subject vehicle, a degree of repetition of each type of action, a motion pattern of the driving behavior, a period of the motion pattern of the driving behavior, and a degree of influence caused by the driving behavior of the subject vehicle to other vehicles, including the ego vehicle. Types of actions that may be performed by the subject vehicle may include nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, lack of headlights, driving a speed limit, driving with the flow of traffic, proper signaling, and driving within a lane. A degree of repetition of a type of action may include an amount and frequency of each type of action being performed. A motion pattern may include a sequence of actions being performed. A sequence of actions may include a sequence of the same type of action or a sequence of a combination of different types of actions. A period of a motion pattern may include an amount of time the motion pattern is being performed. A degree of influence may include an amount and frequency of the influence that the driving behavior of a vehicle has on other vehicles.

At step 404, the computing component 110 determines if there are any potential indicators of unsafe driving from the characteristics of the driving behavior of the subject vehicle. A potential indicator of unsafe driving may include one or more characteristics of the driving behavior, including, for example, particular types of actions, at least a minimum amount of degree of repetition of a type of action, particular types of motion patterns, at least a minimum amount of a period of a motion pattern, and at least a minimum amount of degree of influence on other vehicles. Types of actions that may be a potential indicator of unsafe driving may include, for example, nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, and lack of headlights.

A minimum amount of degree of repetition of a type of action may be a potential indicator of unsafe driving when, for example, the type of action is performed for at least a particular number of times within a particular period of time. The minimum amount of degree of repetition of a type of action may be dependent on the type of action. For example, a minimum amount of degree of repetition for weaving may be more than X weaves by a vehicle in a span of Y seconds. The minimum amount of degree of repetition for a type of action may be predetermined. The minimum amount of degree of repetition for a type of action may be adjusted according to data received of historic driving behavior of vehicles, data received from the road traffic network 360, data received from the road conditions network 370, etc. Many variations are possible.

A motion pattern that may be a potential indicator of unsafe driving when a sequence of actions performed includes, for example, at least two actions, whether the same or different types of actions, that are potential indicators of unsafe driving. A period of a motion pattern may be a potential indicator of unsafe driving when the motion pattern includes one or more types of actions performed within a particular duration of time, such as, for example, one minute, 2 minutes, 5 minutes, 30 seconds, etc. The period of a motion pattern considered as a potential indicator of unsafe driving may be dependent on one or more factors, such as, for example, the time of day, traffic, road conditions, weather, number of surrounding vehicles for the subject vehicle, etc. Road conditions may include, for example, damages to the road, hazardous features on the road (i.e., obstructions), and attributes and characteristics of the road (i.e., the color, size, number of lanes, shape, etc.). An obstruction may include, for example, a pothole, crack, tire marking, faded road marking, debris, object, occlusion, road reflection, flooding, icy surface, oil leak, uneven pavement, erosion and raveling. The data of road conditions obtained may be analyzed by the computing component 110 and used as a factor to determine a period of motion pattern to be considered as a potential indicator of unsafe driving.

A degree of influence may be a potential indicator of unsafe driving when actions performed by a subject vehicle may have a negative effect on one or more other vehicles. A negative effect may include a reaction made by another vehicle or driver of another vehicle from the action performed by the subject vehicle. The reaction action may be an action made in response to bad or unsafe driving. For example, a reaction may include yelling, hand gestures, and accident preventative driving (i.e., changing lanes, slowing down, and speeding up). Many variations are possible.

If one or more potential indicators are determined, proceed to step 406. If no potential indicators are determined, proceed to step 402 to infer characteristics of driving behaviors of vehicles.

At step 406, the computing component 110 selects one or more predictive models according to the determined potential indicators. A predictive model may be a ML model that is used to analyze characteristics of driving behaviors to predict next driving actions of a vehicle. A predictive model may include a reckless behavior prediction model, aggressive behavior prediction model and distracted behavior prediction model. Each predictive model may represent a different category of unsafe driving behaviors. Based on the one or more potential indicators of unsafe driving determined for a subject vehicle, one or more prediction models may be selected. Some potential indicators of unsafe driving may represent more than one category of unsafe driving behaviors. Depending on the combination of one or more potential indicators of unsafe driving determined for a subject vehicle, the computing component 110 may select the most relevant predictive models.

The reckless behavior prediction model may be selected when the determined potential indicators represent that the subject vehicle is being driven in a reckless manner. The reckless behavior prediction model may be selected when the determined potential indicators include, for example, a high degree of repetition of swerving with a motion pattern of swerving and speeding for a duration of over one minute, with a high degree of influence on at least five other vehicles. Another example of determined potential indicators that may lead to the reckless behavior prediction model being selected may include a high degree of repetition of nudging with a motion pattern of nudging, accelerations, decelerations, tailgating, and lack of headlights for a duration of over 30 seconds, with at least a medium degree of influence on at least seven other vehicles. Many variations are possible.

The aggressive behavior prediction model may be selected when the determined potential indicators represent that the subject vehicle is being driven in an aggressive manner. The aggressive behavior prediction model may be selected when the determined potential indicators include, for example, a high degree of repetition of accelerations, decelerations, and nudging within a motion pattern for a duration of over 20 seconds that has at least a medium degree of influence on at least eight other vehicles. Another example of determined potential indicators that may lead to the aggressive behavior prediction model being selected may include a medium degree of repetition of speeding, weaving and tailgating within a motion pattern for a duration of over 30 seconds that has a high degree of influence on at least four other vehicles. Many variations are possible.

The distracted behavior prediction model may be selected when the determined potential indicators represent that the subject vehicle is being driven in a distracted manner. The distracted behavior prediction model may be selected when the determined potential indicators include, for example, a medium degree of repetition of lane drifting and failure to signal within a motion pattern for a duration of over 40 seconds that has at least a medium degree of influence on at least five other vehicles. Another example of determined potential indicators that may lead to the distracted behavior prediction model being selected may include a low degree of repetition of weaving, failure to signal, tailgating, nudging, driving slow and delayed stopping within a motion pattern for a duration of over 30 seconds that has at least a medium degree of influence on at least six other vehicles. Many variations are possible.

There may be a combination of potential indicators of unsafe driving that could represent more than one category of unsafe driving behavior. When more than one category of unsafe driving behavior may be represented by the combination of potential indicators, each predictive model of each respective represented category of unsafe driving may be selected. Potential combinations of predictive models that may be selected may include, for example, the reckless behavior prediction model and aggressive behavior prediction model, the aggressive behavior prediction model and the distracted behavior prediction model, etc. Many variations are possible.

At step 408, the computing component 110 predicts next driving data of the subject vehicle based on the one or more predictive models. The selected predictive model(s) may be used to predict the next driving data of the subject vehicle. The next driving data may include next driving actions that the subject vehicle may perform. The next driving data of the subject vehicle may be predicted according to one or more algorithms of the predictive model(s) based on the potential indicators of unsafe driving that the subject vehicle was determined to have performed and the driving data of the subject vehicle. Each of the predictive models may include one or more algorithms used to determine the predicted next driving data based on the driving data of the subject vehicle and the determined potential indicators of unsafe driving. The one or more algorithms may be pre-stored. The one or more algorithms may include a plurality of equations and methods to determine the predicted next driving data. In other applications, each of the predictive models may include ML and/or AI logic. ML and/or AI logic may be used to determine the predicted next driving data. The ML and/or AI logic may use data from previous sessions, whether on the same subject vehicle or other vehicles, and stored data to more quickly and efficiently determine the predicted next driving data to be performed by the subject vehicle, including, for example, types of actions predicted to be performed and a path of travel to be taken.

At step 410, the computing component 110 runs unsafe driving detection logic with the predicted next driving data. Unsafe driving detection logic may include one or more algorithms used to determine whether the predicted next driving data demonstrates unsafe driving behavior. Unsafe driving detection logic may include one or more algorithms used to determine whether the potential indicators to infer characteristics of driving behavior may be used to identify unsafe driving behavior(s) being performed. The one or more algorithms may be pre-stored. The one or more algorithms may include a plurality of equations and methods to determine unsafe driving behaviors based on predicted next driving data. In other applications, the unsafe driving detection logic may include ML and/or AI logic. ML and/or AI logic may be used to identify unsafe driving behaviors from predicted next driving data. The ML and/or AI logic may use data from previous sessions, whether on the same subject vehicle or other vehicles, and stored data to more quickly and efficiently determine if the predicted next driving data represents unsafe driving behaviors. Many variations are possible.

At step 412, the computing component 110 determines if the subject vehicle is categorized as an unsafe driver from the unsafe driving detection logic. Running the unsafe driving detection logic with the predicted driving data may determine if the subject vehicle is predicted to perform unsafe driving behaviors. If it is determined that the subject vehicle is predicted to perform unsafe driving behaviors, then the subject vehicle may be identified as an unsafe driver. Otherwise, if it is determined that the subject vehicle is predicted to perform safe driving behaviors, then the subject vehicle may be identified to not be an unsafe driver.

If the subject vehicle is determined to be an unsafe driver, proceed to step 414. Otherwise, proceed to step 402 to infer characteristics of driving behaviors of one or more other vehicles.

At step 414, the computing component 110 notifies a driver of an ego vehicle that the subject vehicle is an unsafe driver. Upon a determination that the subject vehicle is an unsafe driver because the unsafe driving detection logic predicted the subject vehicle to perform unsafe driving behaviors, then the ego vehicle may be notified of the subject vehicle being an unsafe driver. The notification may include a location of the subject vehicle in relation to the ego vehicle. The ego vehicle may also be notified of the predicted next driving actions of the subject vehicle. The notification may include suggestive actions for the ego vehicle to perform to navigate away from the subject vehicle based on the predicted next driving actions of the subject vehicle. The notification may include a message that may be displayed on a screen of the ego vehicle. The notification to the ego vehicle may assist the ego vehicle to avoid the subject vehicle.

At step 416, the computing component 110 monitors the driving behavior of the subject vehicle to determine if the actual next driving actions performed by the subject vehicle match the predicted next driving actions determined by the one or more predictive models. While monitoring the driving behavior of the subject vehicle, the computing component 110 may identify the actual next driving actions performed by the subject vehicle. The computing component 110 may compare the actual next driving actions with the predicted next driving actions. The computing component 110 may determine if the actual next driving actions performed by the subject vehicle match the predicted next driving actions. For example, the computing component 110 may determine the Euclidian distance between the actual next driving action and the predict next driving action. If the determined Euclidian distance is less than a threshold, the actual next driving action may be determined to be the same or similar to the predicted next driving action. The threshold may be predetermined and preset. The threshold may vary according to one or more factors, including, for example, the type of action of the actual next driving action, the type of action of the predicted next driving action, environmental data, the time of day, traffic, road conditions, weather, number of surrounding vehicles the ego vehicle, the subject vehicle, etc.

If the actual next driving actions of the subject vehicle do not match the predicted next driving actions determined by the one or more predictive models, proceed to step 418. If the actual next driving actions of the subject vehicle do match the predicted next driving actions determined by the one or more predictive models, then proceed to step 402 to infer characteristics of the driving behavior of other vehicles as the predictive models are being accurately selected based on the characteristics of a driving behavior of a vehicle and accurately predicting next driving actions using the predictive models.

At step 418, the computing component 110 refines the one or more predictive models based on the accuracy of the actual next driving actions compared to the predicted next driving actions. If the actual next driving actions performed by the subject vehicle are determined to not match the predicted next driving actions, then the computing component 110 may determine that the at least one of the following may need to be updated and refined: (i) the potential indicators of unsafe driving, (ii) the predictive model(s) selected based on the potential indicators of unsafe driving, (iii) the algorithm(s) in the predictive model(s) in predicting the next driving data, and (iv) the unsafe driving detection logic used to determine if the predicted next driving data includes actions categorized as unsafe driving behaviors. Refining at least one of the potential indicators, predictive model(s) selection, predictive model(s) algorithm(s), and unsafe driving detection logic may improve the accuracy and efficiency in detecting and characterizing driving behaviors of vehicles to determine unsafe drivers on the road.

For simplicity of description, the process 400 is described as being performed with respect to a single detected subject vehicle. It should be appreciated that, in a typical embodiment, the computing component 110 may manage the detection of a plurality of subject vehicles, at various locations, in short succession of one another. For example, in some embodiments, the computing component 110 can perform many, if not all, of the steps in process 400 on a plurality of detected subject vehicles as data of driving behaviors of vehicles are obtained.

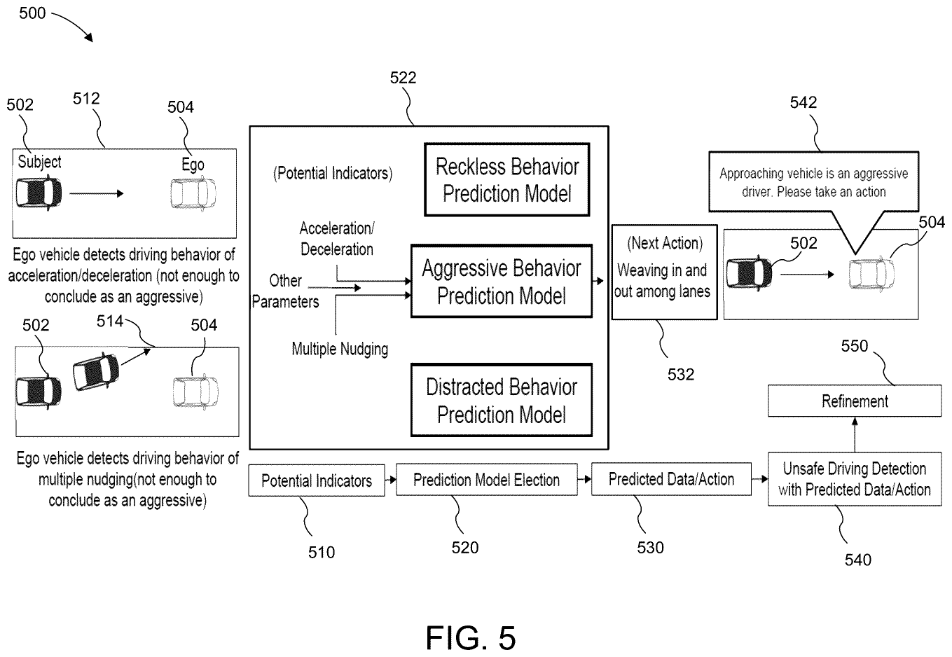

FIG. 5 illustrates an example predictive driving behavior system 500. The predictive driving behavior system 500 may be configured to detect unsafe driving behaviors of a vehicle, such as, for example, vehicle 150 of FIG. 1 and subject vehicle 502, and refine predictive analysis of driving actions to be performed by the vehicle. The predictive driving behavior system 500 may send results of detected unsafe driving behaviors and predictive driving actions of a subject vehicle 502 to one or more other vehicles within a vicinity and/or traveling path of the subject vehicle 502. The predictive driving behavior system 500 may be performed on one or more vehicles traveling on a road, including subject vehicle 502, ego vehicle 504, etc. The predictive driving behavior system 500 may be implemented by one or more vehicles, such as, for example, ego vehicle 504, to determine whether subject vehicle 502 is performing unsafe driving behaviors and pose a danger to ego vehicle 504. The one or more vehicles implementing the predictive driving behavior system 500 may form a P2P or V2V network to communicate with one another and send data of unsafe driving behaviors and predictive analysis of driving actions to each other. Many variations are possible.

At step 510, the predictive driving behavior system 500 may determine potential indicators of unsafe driving behavior. The ego vehicle 504 may be traveling on a road. The subject vehicle 502 may be traveling on the same road as and in a direction towards the ego vehicle 504. The ego vehicle 504 and subject vehicle 502 may include, for example, an automobile, truck, motorcycle, bicycle, scooter, moped, recreational vehicle and other like on-or off-road vehicles. The ego vehicle 504 and subject vehicle 502 may include, for example, an autonomous, semi-autonomous and manual operation. Each of the ego vehicle 504 and subject vehicle 502 may include one or more sensors that may be used to collect data of the driving behavior of itself and the driving behavior of each of one or more other vehicles. Each of one or more other vehicles may include one or more sensors that may be used to collect data of the driving behavior of the ego vehicle 504, subject vehicle 502, themselves, and of each of the other vehicles.

The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received by at least one sensor of a vehicle. The ego vehicle 504 may be in a position on a road that is in an approximate area of a path of travel of the subject vehicle 502. The approximate area of a path of travel of the subject vehicle 502 may include a position that is in front, behind, or on either side of the subject vehicle 502 as the subject vehicle 502 is traveling on the road. The predictive driving behavior system 500 may use one or more sensors of a vehicle, such as ego vehicle 504, to collect the data of the driving behavior of the subject vehicle 504. The predictive driving behavior system 500 may combine data of the driving behavior of the subject vehicle 502 collected by one or more sensors of the ego vehicle 504 with data of the driving behavior of the subject vehicle 502 collected by one or more sensors of one or more other vehicles and of the road, such as, for example, road cameras, road sensors, etc.

The data of the driving behavior of the subject vehicle 502 may include information on one or more driving actions performed by the subject vehicle 502, including the speed, movements (or lack of movements), and direction of travel of the subject vehicle 502. The data of the driving behavior of the subject vehicle 502 may include an identity of a driver of the subject vehicle 502. The data of the driving behavior of the subject vehicle 502 may be used by the predictive driving behavior system 500 to infer characteristics of the driving behavior. Data of the driving of one or more other vehicles may be used to infer characteristics of the driving behavior of the subject vehicle 502. Characteristics of the driving behavior of the subject vehicle 502 may include one or more types of actions performed by the subject vehicle 502, a degree of repetition of each type of action, a motion pattern of the driving behavior, a period of the motion pattern of the driving behavior, and a degree of influence caused by the driving behavior of the subject vehicle 502 to other vehicles, including the ego vehicle 504. Types of actions that may be performed by the subject vehicle 502 may include nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, lack of headlights, driving a speed limit, driving with the flow of traffic, proper signaling, and driving within a lane. A degree of repetition of a type of action may include an amount and frequency of each type of action being performed. A motion pattern may include a sequence of actions being performed. A sequence of actions may include a sequence of the same type of action or a sequence of a combination of different types of actions. A period of a motion pattern may include an amount of time the motion pattern is being performed. A degree of influence may include an amount and frequency of the influence that the driving behavior of a vehicle has on other vehicles.

The predictive driving behavior system 500 may determine if there are any potential indicators of unsafe driving from the characteristics of the driving behavior of the subject vehicle 504. A potential indicator of unsafe driving may include one or more characteristics of the driving behavior, including, for example, particular types of actions, at least a minimum amount of degree of repetition of a type of action, particular types of motion patterns, at least a minimum amount of a period of a motion pattern, and at least a minimum amount of degree of influence on other vehicles. Types of actions that may be a potential indicator of unsafe driving may include, for example, nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, and lack of headlights.

A minimum amount of degree of repetition of a type of action may be a potential indicator of unsafe driving when, for example, the type of action is performed for at least a particular number of times within a particular period of time. A motion pattern that may be a potential indicator of unsafe driving when a sequence of actions performed includes, for example, at least two actions, whether the same or different types of actions, that are potential indicators of unsafe driving. A period of a motion pattern may be a potential indicator of unsafe driving when the motion pattern includes one or more types of actions performed within a particular duration of time, such as, for example, one minute, 2 minutes, 5 minutes, 30 seconds, etc. The period of a motion pattern considered as a potential indicator of unsafe driving may be dependent on one or more factors, such as, for example, the time of day, traffic, road conditions, weather, number of surrounding vehicles for the subject vehicle 502, etc. Road conditions may include, for example, damages to the road, hazardous features on the road (i.e., obstructions), and attributes and characteristics of the road (i.e., the color, size, number of lanes, shape, etc.). An obstruction may include, for example, a pothole, crack, tire marking, faded road marking, debris, object, occlusion, road reflection, flooding, icy surface, oil leak, uneven pavement, erosion and raveling. The data of road conditions obtained may be analyzed by the predictive driving behavior system 500 and used as a factor to determine a period of motion pattern to be considered as a potential indicator of unsafe driving.

A degree of influence may be a potential indicator of unsafe driving when actions performed by the subject vehicle 502 may have a negative effect on one or more other vehicles. A negative effect may include a reaction made by another vehicle or driver of another vehicle from the action performed by the subject vehicle 502. The reaction action may be an action made in response to bad or unsafe driving. For example, a reaction may include yelling, hand gestures, and accident preventative driving (i.e., changing lanes, slowing down, and speeding up). Many variations are possible.

In block 512, the predictive driving behavior system 500 may determine that the subject vehicle 502 is performing driving behavior characteristics of acceleration and deceleration. The predictive driving behavior system 500 may determine that the driving behavior characteristics of acceleration and deceleration are each categorized as a potential indicator of unsafe driving. The predictive driving behavior system 500 may determine that the subject vehicle 502 is performing accelerations and decelerations in a degree of repetition that is high enough to be considered as a potential indicator.

In block 514, the predictive driving behavior system 500 may determine that the subject vehicle 502 is performing a driving behavior characteristic of nudging. The predictive driving behavior system 500 may determine that the driving behavior characteristic of nudging is categorized as a potential indicator of unsafe driving. The predictive driving behavior system 500 may determine that the subject vehicle 502 is performing nudging in a degree of repetition that is high enough to be considered as a potential indicator.

In step 520, the predictive driving behavior system 500 may elect one or more prediction models according to the determined potential indicator characteristics of the subject vehicle 502. A prediction model may be a ML model that is used to analyze characteristics of driving behaviors to predict next driving actions of a vehicle. A prediction model may include a reckless behavior prediction model, aggressive behavior prediction model and distracted behavior prediction model. Each prediction model may represent a different category of unsafe driving behaviors. Based on the one or more potential indicators of unsafe driving determined for the subject vehicle 502, one or more prediction models may be selected. Some potential indicators of unsafe driving may represent more than one category of unsafe driving behaviors. Depending on the combination of one or more potential indicators of unsafe driving determined for the subject vehicle 502, the predictive driving behavior system 500 may select the most relevant prediction model(s).

The reckless behavior prediction model may be selected when the determined potential indicators represent that the subject vehicle is being driven in a reckless manner. The aggressive behavior prediction model may be selected when the determined potential indicators represent that the subject vehicle is being driven in an aggressive manner. The distracted behavior prediction model may be selected when the determined potential indicators represent that the subject vehicle is being driven in a distracted manner. There may be a combination of potential indicators of unsafe driving that could represent more than one category of unsafe driving behavior. When more than one category of unsafe driving behavior may be represented by the combination of potential indicators, each prediction model of each respective represented category of unsafe driving may be selected. Potential combinations of prediction models that may be selected may include, for example, the reckless behavior prediction model and aggressive behavior prediction model, the aggressive behavior prediction model and the distracted behavior prediction model, etc. Many variations are possible.

Based on the potential indicator characteristics of acceleration and deceleration with a high degree of repetition as determined in block 512 and nudging with a high degree of repetition as determined in block 514, the predictive driving behavior system 500 may determine that the subject vehicle 502 is being driven in an aggressive manner. As such, the predictive driving behavior system 500 may select the aggressive behavior prediction model. Other parameters may also be considered by the predictive driving behavior system 500 to lead the predictive driving behavior system 500 to determine the subject vehicle 502 is being driven in an aggressive manner and select the aggressive behavior prediction model. Other parameters may include a motion pattern, a duration of motion pattern, a degree of influence on other vehicles and objects, and environmental data.

In step 530, the predictive driving behavior system 500 may predict next driving data of the subject vehicle 502 based on the aggressive behavior prediction model. The selected aggressive behavior prediction model may be used to predict the next driving data of the subject vehicle 502. The next driving data may include next driving actions that the subject vehicle 502 may perform. The next driving data of the subject vehicle 502 may be predicted according to one or more algorithms of the aggressive behavior prediction model based on the potential indicators characteristics of acceleration and deceleration with a high degree of repetition and nudging with a high degree of repetition performed by the subject vehicle 502. The aggressive behavior prediction model may predict that the next driving data includes a next driving action 532 of weaving in and out among lanes that the subject vehicle 502 will perform.

In step 540, the predictive driving behavior system 500 may determine if unsafe driving is detected from the predicted next driving data of the subject vehicle 502. Unsafe driving detection logic may be run to analyze the predicted next driving data of the subject vehicle 502 and determine if the subject vehicle 502 is predicted to perform unsafe driving. The unsafe driving detection logic may include one or more algorithms used to determine whether the predicted next driving data demonstrates unsafe driving behavior. The one or more algorithms may be pre-stored. The one or more algorithms may include a plurality of equations and methods to determine unsafe driving behaviors based on predicted next driving data. In other applications, the unsafe driving detection logic may include ML and/or AI logic. ML and/or AI logic may be used to identify unsafe driving behaviors from predicted next driving data. The ML and/or AI logic may use data from previous sessions, whether on the same subject vehicle 502 or other vehicles, and stored data to more quickly and efficiently determine if the predicted next driving data represents unsafe driving behaviors. Many variations are possible.

Running the unsafe driving detection logic with the predicted next driving data may determine that the predicted next driving action 532 of weaving in and out among lanes is categorized as an unsafe driving behavior. As such, the predictive driving behavior system 500 may determine that the subject vehicle 502 is predicted to perform unsafe driving. The predictive driving behavior system 500 may send a notification 542 to the ego vehicle 504 that the subject vehicle 502 is predicted to perform unsafe driving. The notification 542 may include a location of the subject vehicle 502 in relation to the ego vehicle 504. The notification 542 may also include the predicted next driving action 532 of the subject vehicle 502. The notification 542 may include suggestive actions for the ego vehicle 504 to perform to navigate away from the subject vehicle 502 based on the predicted next driving action 532 of the subject vehicle 502. The notification 542 may include a message that may be displayed on a screen of the ego vehicle 504. The notification 542 to the ego vehicle 504 may assist the ego vehicle 504 to avoid the subject vehicle 502.

In step 550, the predictive driving behavior system 500 may perform refinement of the potential indicator characteristics, aggressive behavior prediction model and unsafe driving detection logic. Before performing refinement, the predictive driving behavior system 500 may monitor the driving behavior of the subject vehicle 502 to determine if the actual next driving action performed by the subject vehicle 502 matches the predicted next driving action 532 determined by using the aggressive behavior prediction model. While monitoring the driving behavior of the subject vehicle 502, the predictive driving behavior system 500 may identify the actual next driving action performed by the subject vehicle 502. The predictive driving behavior system 500 may compare the actual next driving action with the predicted next driving action 532. The predictive driving behavior system 500 may determine if the actual next driving action performed by the subject vehicle 502 matches the predicted next driving action 532.

If the actual next driving action of the subject vehicle 502 matches the predicted next driving action 532 determined from using the aggressive behavior prediction model, then the predictive driving behavior system 500 may infer that determining potential indicator characteristics, electing and using the aggressive behavior prediction model, and performing the unsafe driving detection logic are accurate. Otherwise, if the actual next driving action of the subject vehicle 502 does not match the predicted next driving action 532 determined from the aggressive behavior prediction model, then the predictive driving behavior system 500 may determine that at least one of the following may need to be updated and refined: (i) the potential indicator characteristics of unsafe driving, (ii) the aggressive behavior prediction model selected based on the potential indicator characteristics of unsafe driving, (iii) the algorithm(s) in the aggressive behavior prediction model in predicting the next driving data, and (iv) the unsafe driving detection logic used to determine if the predicted next driving data includes actions categorized as an unsafe driving behavior. Refining at least one of the potential indicator characteristics, aggressive behavior prediction model selection, aggressive behavior prediction model algorithm(s), and unsafe driving detection logic may improve the accuracy and efficiency in detecting and characterizing driving behaviors of vehicles to determine unsafe drivers on the road.

The predictive driving behavior system 500 may be implemented as the computing component 110 of FIG. 1, the computing system 210 of FIG. 2, the predictive driving behavior system 300 of FIG. 3 and the process 400 of FIG. 4.

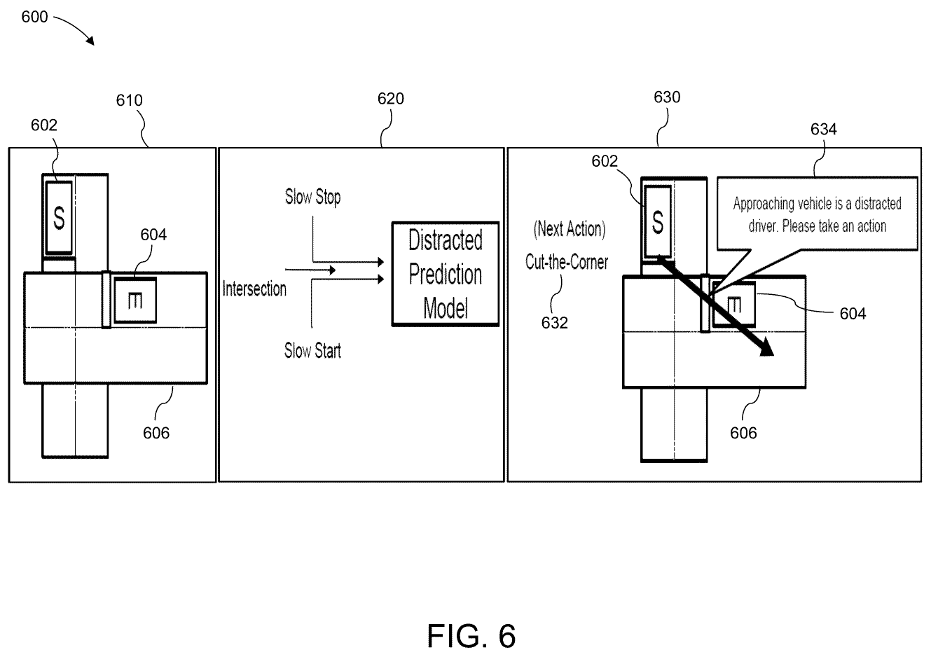

FIG. 6 illustrates an example predictive driving behavior system 600. The predictive driving behavior system 600 may be configured to detect unsafe driving behaviors of a vehicle, such as, for example, vehicle 150 of FIG. 1 and subject vehicle 602, and refine predictive analysis of driving actions to be performed by the vehicle. The predictive driving behavior system 600 may send results of detected unsafe driving behaviors and predictive driving actions of a subject vehicle 602 to one or more other vehicles within a vicinity and/or traveling path of the subject vehicle 602, including, for example, ego vehicle 604. The predictive driving behavior system 600 may be performed on one or more vehicles traveling on a road, including subject vehicle 602, ego vehicle 604, etc. The predictive driving behavior system 600 may be implemented by one or more vehicles, such as, for example, ego vehicle 604, to determine whether subject vehicle 602 is performing unsafe driving behaviors and pose a danger to ego vehicle 604. The one or more vehicles implementing the predictive driving behavior system 600 may form a P2P or V2V network to communicate with one another and send data of unsafe driving behaviors and predictive analysis of driving actions to each other. Many variations are possible.

At step 610, the predictive driving behavior system 600 may determine potential indicators of unsafe driving behavior of subject vehicle 602. The ego vehicle 604 may be traveling on a first road. The subject vehicle 602 may be traveling on a second road that is in direct contact with the first road of the ego vehicle 604, where the first road and second road are contacted at an intersection 606, as shown in FIG. 6. Each of the ego vehicle 604 and subject vehicle 602 may include one or more sensors that may be used to collect data of the driving behavior of itself and the driving behavior of each of one or more other vehicles. Each of one or more other vehicles may include one or more sensors that may be used to collect data of the driving behavior of the ego vehicle 604, subject vehicle 602, themselves, and of each of the other vehicles.

Data may be received by at least one sensor of a vehicle. The ego vehicle 604 may be in a position on a road that is in an approximate area of a path of travel of the subject vehicle 602. The approximate area of a path of travel of the subject vehicle 602 may include a position that is in front, behind, or on either side of the subject vehicle 602 as the subject vehicle 602 is traveling on the road. The predictive driving behavior system 600 may use one or more sensors of a vehicle, such as ego vehicle 604, to collect the data of the driving behavior of the subject vehicle 604. The predictive driving behavior system 600 may combine data of the driving behavior of the subject vehicle 602 collected by one or more sensors of the ego vehicle 604 with data of the driving behavior of the subject vehicle 602 collected by one or more sensors of one or more other vehicles and of the road, such as, for example, road cameras, road sensors, etc.

The data of the driving behavior of the subject vehicle 602 may include information on one or more driving actions performed by the subject vehicle 602, including the speed, movements (or lack of movements), and direction of travel of the subject vehicle 602. The data of the driving behavior of the subject vehicle 602 may include an identity of a driver of the subject vehicle 602. The predictive driving behavior system 600 may determine that the subject vehicle 602 will attempt to turn left at the intersection 606 of the first and second roads.

The data of the driving behavior of the subject vehicle 602 may be used by the predictive driving behavior system 600 to infer characteristics of the driving behavior. The data of the driving behavior of one or more other vehicles may be used to infer characteristics of the driving behavior of the subject vehicle 602. Characteristics of the driving behavior of the subject vehicle 602 may include one or more types of actions performed by the subject vehicle 602, a degree of repetition of each type of action, a motion pattern of the driving behavior, a period of the motion pattern of the driving behavior, and a degree of influence caused by the driving behavior of the subject vehicle 602 to other vehicles, including the ego vehicle 604. Types of actions that may be performed by the subject vehicle 602 may include nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, lack of headlights, driving a speed limit, driving with the flow of traffic, proper signaling, and driving within a lane. A degree of repetition of a type of action may include an amount and frequency of each type of action being performed. A motion pattern may include a sequence of actions being performed. A sequence of actions may include a sequence of the same type of action or a sequence of a combination of different types of actions. A period of a motion pattern may include an amount of time the motion pattern is being performed. A degree of influence may include an amount and frequency of the influence that the driving behavior of a vehicle has on other vehicles.

The predictive driving behavior system 600 may determine if there are any potential indicators of unsafe driving from the characteristics of the driving behavior of the subject vehicle 604. A potential indicator of unsafe driving may include one or more characteristics of the driving behavior, including, for example, particular types of actions, at least a minimum amount of degree of repetition of a type of action, particular types of motion patterns, at least a minimum amount of a period of a motion pattern, and at least a minimum amount of degree of influence on other vehicles. Types of actions that may be a potential indicator of unsafe driving may include, for example, nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, and lack of headlights.

A minimum amount of degree of repetition of a type of action may be a potential indicator of unsafe driving when, for example, the type of action is performed for at least a particular number of times within a particular period of time. A motion pattern that may be a potential indicator of unsafe driving when a sequence of actions performed includes, for example, at least two actions, whether the same or different types of actions, that are potential indicators of unsafe driving. A period of a motion pattern may be a potential indicator of unsafe driving when the motion pattern includes one or more types of actions performed within a particular duration of time, such as, for example, one minute, 2 minutes, 5 minutes, 30 seconds, etc. The period of a motion pattern considered as a potential indicator of unsafe driving may be dependent on one or more factors, such as, for example, the time of day, traffic, road conditions, weather, number of surrounding vehicles for the subject vehicle 602, etc. Road conditions may include, for example, damages to the road, hazardous features on the road (i.e., obstructions), and attributes and characteristics of the road (i.e., the color, size, number of lanes, shape, etc.). An obstruction may include, for example, a pothole, crack, tire marking, faded road marking, debris, object, occlusion, road reflection, flooding, icy surface, oil leak, uneven pavement, erosion and raveling. The data of road conditions obtained may be analyzed by the predictive driving behavior system 600 and used as a factor to determine a period of motion pattern to be considered as a potential indicator of unsafe driving.

A degree of influence may be a potential indicator of unsafe driving when actions performed by the subject vehicle 602 may have a negative effect on one or more other vehicles. A negative effect may include a reaction made by another vehicle or driver of another vehicle from the action performed by the subject vehicle 602. The reaction action may be an action made in response to bad or unsafe driving. For example, a reaction may include yelling, hand gestures, and accident preventative driving (i.e., changing lanes, slowing down, and speeding up). Many variations are possible.

The predictive driving behavior system 600 may determine that the subject vehicle 602 is performing driving behavior characteristics of slow stop and slow start. The predictive driving behavior system 600 may determine that the driving behavior characteristics of slow stop and slow start are each categorized as a potential indicator of unsafe driving. The predictive driving behavior system 600 may determine that the subject vehicle 602 is performing slow stop and slow start with a motion pattern duration that is high enough to be considered as a potential indicator.

In step 620, the predictive driving behavior system 600 may elect one or more prediction models according to the determined potential indicator characteristics of the subject vehicle 602. A prediction model may be a ML model that is used to analyze characteristics of driving behaviors to predict next driving actions of a vehicle. A prediction model may include a reckless behavior prediction model, aggressive behavior prediction model and distracted behavior prediction model. Each prediction model may represent a different category of unsafe driving behaviors. Based on the one or more potential indicators of unsafe driving determined for the subject vehicle 602, one or more prediction models may be selected. Some potential indicators of unsafe driving may represent more than one category of unsafe driving behaviors. Depending on the combination of one or more potential indicators of unsafe driving determined for the subject vehicle 602, the predictive driving behavior system 600 may select the most relevant prediction model(s).

The reckless behavior prediction model may be selected when the determined potential indicators represent that the subject vehicle is being driven in a reckless manner. The aggressive behavior prediction model may be selected when the determined potential indicators represent that the subject vehicle is being driven in an aggressive manner. The distracted behavior prediction model may be selected when the determined potential indicators represent that the subject vehicle is being driven in a distracted manner. There may be a combination of potential indicators of unsafe driving that could represent more than one category of unsafe driving behavior. When more than one category of unsafe driving behavior may be represented by the combination of potential indicators, each prediction model of each respective represented category of unsafe driving may be selected. Potential combinations of prediction models that may be selected may include, for example, the reckless behavior prediction model and aggressive behavior prediction model, the aggressive behavior prediction model and the distracted behavior prediction model, etc. Many variations are possible.

Based on the potential indicator characteristics of slow stop and slow start with a high motion pattern duration, as determined in step 610, the predictive driving behavior system 600 may determine that the subject vehicle 602 is being driven in a distracted manner. As such, the predictive driving behavior system 600 may select the distracted behavior prediction model. Other parameters may also be considered by the predictive driving behavior system 600 to lead the predictive driving behavior system 600 to determine the subject vehicle 602 is being driven in a distracted manner and select the distracted behavior prediction model. Other parameters may include a repetition of driving actions, a degree of influence on other vehicles and objects, and environmental data.

In step 630, the predictive driving behavior system 600 may predict next driving data of the subject vehicle 602 based on the distracted behavior prediction model. The selected distracted behavior prediction model may be used to predict the next driving data of the subject vehicle 602. The next driving data may include next driving actions that the subject vehicle 602 may perform. The next driving data of the subject vehicle 602 may be predicted according to one or more algorithms of the distracted behavior prediction model based on the potential indicators characteristics of slow stop and slow start with a high motion pattern duration performed by the subject vehicle 602. The distracted behavior prediction model may predict that the next driving data includes a next driving action 632 of cutting the corner of the lane when making a left turn that the subject vehicle 602 will perform.

The predictive driving behavior system 600 may determine if unsafe driving is detected from the predicted next driving data of the subject vehicle 602. Unsafe driving detection logic may be run to analyze the predicted next driving data of the subject vehicle 602 and determine if the subject vehicle 602 is predicted to perform unsafe driving. The unsafe driving detection logic may include one or more algorithms used to determine whether the predicted next driving data demonstrates unsafe driving behavior. The one or more algorithms may be pre-stored. The one or more algorithms may include a plurality of equations and methods to determine unsafe driving behaviors based on predicted next driving data. In other applications, the unsafe driving detection logic may include ML and/or AI logic. ML and/or AI logic may be used to identify unsafe driving behaviors from predicted next driving data. The ML and/or AI logic may use data from previous sessions, whether on the same subject vehicle 602 or other vehicles, and stored data to more quickly and efficiently determine if the predicted next driving data represents unsafe driving behaviors. Many variations are possible.

Running the unsafe driving detection logic with the predicted next driving data may determine that the predicted next driving action 632 of cutting the corner of the lane when making a left turn is categorized as an unsafe driving behavior. As such, the predictive driving behavior system 600 may determine that the subject vehicle 602 is predicted to perform unsafe driving. The predictive driving behavior system 600 may send a notification 634 to the ego vehicle 604 that the subject vehicle 602 is predicted to perform unsafe driving. The notification 634 may include a location of the subject vehicle 602 in relation to the ego vehicle 604. The notification 634 may include the predicted next driving action 632 of the subject vehicle 602. The notification 634 may include suggestive actions for the ego vehicle 604 to perform to navigate away from the subject vehicle 602 based on the predicted next driving action 632 of the subject vehicle 602. The notification 634 may include a message that may be displayed on a screen of the ego vehicle 604. The notification 634 to the ego vehicle 604 may assist the ego vehicle 604 to avoid the subject vehicle 602.

The predictive driving behavior system 600 may perform refinement of the potential indicator characteristics, distracted behavior prediction model and unsafe driving detection logic. Before performing refinement, the predictive driving behavior system 600 may monitor the driving behavior of the subject vehicle 602 to determine if the actual next driving action performed by the subject vehicle 602 matches the predicted next driving action 632 determined by using the distracted behavior prediction model. While monitoring the driving behavior of the subject vehicle 602, the predictive driving behavior system 600 may identify the actual next driving action performed by the subject vehicle 602. The predictive driving behavior system 600 may compare the actual next driving action with the predicted next driving action 632. The predictive driving behavior system 600 may determine if the actual next driving action performed by the subject vehicle 602 matches the predicted next driving action 632.

If the actual next driving action of the subject vehicle 602 matches the predicted next driving action 632 determined from using the distracted behavior prediction model, then the predictive driving behavior system 600 may infer that determining potential indicator characteristics, electing and using the distracted behavior prediction model, and performing the unsafe driving detection logic are accurate. Otherwise, if the actual next driving action of the subject vehicle 602 does not match the predicted next driving action 632 determined from the distracted behavior prediction model, then the predictive driving behavior system 600 may determine that at least one of the following may need to be updated and refined: (i) the potential indicator characteristics of unsafe driving, (ii) the distracted behavior prediction model selected based on the potential indicator characteristics of unsafe driving, (iii) the algorithm(s) in the distracted behavior prediction model in predicting the next driving data, and (iv) the unsafe driving detection logic used to determine if the predicted next driving data includes actions categorized as an unsafe driving behavior. Refining at least one of the potential indicator characteristics, distracted behavior prediction model selection, distracted behavior prediction model algorithm(s), and unsafe driving detection logic may improve the accuracy and efficiency in detecting and characterizing driving behaviors of vehicles to determine unsafe drivers on the road.

The predictive driving behavior system 600 may be implemented as the computing component 110 of FIG. 1, the computing system 210 of FIG. 2, the predictive driving behavior system 300 of FIG. 3, the process 400 of FIG. 4 and the predictive driving behavior system 500 of FIG. 5.

FIG. 7 illustrates an example computing component 700 that includes one or more hardware processors 702 and machine-readable storage media 704 storing a set of machine-readable/machine-executable instructions that, when executed, cause the hardware processor(s) 702 to perform an illustrative method of verifying obstructions. It should be appreciated that there can be additional, fewer, or alternative steps performed in similar or alternative orders, or in parallel, within the scope of the various examples discussed herein unless otherwise stated. The computing component 700 may be implemented as the computing component 110 of FIG. 1, the computing system 210 of FIG. 2, the predictive driving behavior system 300 of FIG. 3, the process 400 of FIG. 4, the predictive driving behavior system 500 of FIG. 5 and the predictive driving behavior system 600 of FIG. 6.

At step 706, the hardware processor(s) 702 may execute machine-readable/machine-executable instructions stored in the machine-readable storage media 704 to receive driving data of an ego vehicle. An ego vehicle may be traveling on a road. The ego vehicle may include, for example, an automobile, truck, motorcycle, bicycle, scooter, moped, recreational vehicle and other like on-or off-road vehicles. The ego vehicle may include, for example, an autonomous, semi-autonomous and manual operation. The ego vehicle may include one or more sensors that may be used to collect data of the driving behavior of itself and the driving behavior of each of one or more other vehicles. Each of the one or more other vehicles may include one or more sensors that may be used to collect data of the driving behavior of itself and the driving behavior of each of the other vehicles, including the ego vehicle. Other sensors of roads, infrastructures, etc., may collect driving data on the ego vehicle and each of the other vehicles. Many variations are possible.

The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received by at least one sensor. The ego vehicle may be monitored while traveling on the road to obtain driving data of the ego vehicle. One or more sensors may be used to collect the driving data of the ego vehicle. The driving data of the ego vehicle collected from multiple sensors may be combined to provide a collective and complete driving data. Driving data of the ego vehicle may be collected by one or more sensors of the ego vehicle, one or more sensors of one or more other vehicles, and one or more sensors of the road, such as, for example, road cameras, road sensors, etc.

At step 708, the hardware processor(s) 702 may execute machine-readable/machine-executable instructions stored in the machine-readable storage media 704 to analyze the driving data to determine a driving behavior of the ego vehicle. The driving data of the ego vehicle that is collected may include information of the driving behavior of the ego vehicle. The information of the driving behavior of the ego vehicle may include information on one or more driving actions performed by the ego vehicle, including, for example, the speed, movements (or lack of movements), location, and direction of travel of the ego vehicle. The driving data of the ego vehicle may include an identity of a driver of the ego vehicle. The information of the driving behavior may be associated with the identity of the driver.

At step 710, the hardware processor(s) 702 may execute machine-readable/machine-executable instructions stored in the machine-readable storage media 704 to infer a characteristic of the driving behavior of the ego vehicle. The driving data of the driving behavior of the ego vehicle may be used to infer characteristics of the driving behavior. The driving data of one or more other vehicles may be used to infer characteristics of the driving behavior of the ego vehicle. Characteristics of the driving behavior of the ego vehicle may include one or more types of actions performed by the ego vehicle, a degree of repetition of each type of action, a motion pattern of the driving behavior, a period of the motion pattern of the driving behavior, and a degree of influence caused by the driving behavior of the ego vehicle to other vehicles. Types of actions that may be performed by the ego vehicle may include nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, lack of headlights, driving a speed limit, driving with the flow of traffic, proper signaling, and driving within a lane. A degree of repetition of a type of action may include an amount and frequency of each type of action being performed. A motion pattern may include a sequence of actions being performed. A sequence of actions may include a sequence of the same type of action or a sequence of a combination of different types of actions. A period of a motion pattern may include an amount of time the motion pattern is being performed. A degree of influence may include an amount and frequency of the influence that the driving behavior of a vehicle has on other vehicles.

At step 712, the hardware processor(s) 702 may execute machine-readable/machine-executable instructions stored in the machine-readable storage media 704 to elect a prediction model according to the characteristic of the driving behavior. After characteristics of the driving behavior have been inferred, one or more prediction models may be elected based on the characteristics. Some characteristics may be potential indicators of unsafe driving of a vehicle. A potential indicator of unsafe driving may include one or more characteristics of the driving behavior, including, for example, particular types of actions, at least a minimum amount of degree of repetition of a type of action, particular types of motion patterns, at least a minimum amount of a period of a motion pattern, and at least a minimum amount of degree of influence on other vehicles. Types of actions that may be a potential indicator of unsafe driving may include, for example, nudging, accelerating, decelerating, braking, weaving, swerving, failing to signal, incorrect signaling, tailgating, lane drifting, failing to stop, failing to slow down, speeding, driving slow, delayed stopping, delayed accelerations, honking, flashing headlights, and lack of headlights.

A minimum amount of degree of repetition of a type of action may be a potential indicator of unsafe driving when, for example, the type of action is performed for at least a particular number of times within a particular period of time. The minimum amount of degree of repetition of a type of action may be dependent on the type of action. For example, a minimum amount of degree of repetition for weaving may be more than 3 weaves by a vehicle in a span of 10 seconds. The minimum amount of degree of repetition for a type of action may be predetermined. The minimum amount of degree of repetition for a type of action may be adjusted according to data received of historic driving behavior of vehicles, data received from the road traffic network 360, data received from the road conditions network 370, etc. Many variations are possible.

A motion pattern that may be a potential indicator of unsafe driving when a sequence of actions performed includes, for example, at least two actions, whether the same or different types of actions, that are potential indicators of unsafe driving. A period of a motion pattern may be a potential indicator of unsafe driving when the motion pattern includes one or more types of actions performed within a particular duration of time, such as, for example, one minute, 2 minutes, 5 minutes, 30 seconds, etc. The period of a motion pattern considered as a potential indicator of unsafe driving may be dependent on one or more factors, such as, for example, the time of day, traffic, road conditions, weather, number of surrounding vehicles the ego vehicle, etc. Road conditions may include, for example, damages to the road, hazardous features on the road (i.e., obstructions), and attributes and characteristics of the road (i.e., the color, size, number of lanes, shape, etc.). An obstruction may include, for example, a pothole, crack, tire marking, faded road marking, debris, object, occlusion, road reflection, flooding, icy surface, oil leak, uneven pavement, erosion and raveling. The data of road conditions obtained may be analyzed by the computing component 110 and used as a factor to determine a period of motion pattern to be considered as a potential indicator of unsafe driving.

A degree of influence may be a potential indicator of unsafe driving when actions performed by an ego vehicle may have a negative effect on one or more other vehicles. A negative effect may include a reaction made by another vehicle or driver of another vehicle from the action performed by the ego vehicle. The reaction action may be an action made in response to bad or unsafe driving. For example, a reaction may include yelling, hand gestures, and accident preventative driving (i.e., changing lanes, slowing down, and speeding up). Many variations are possible.

If any inferred characteristics of the driving behavior is determined to be a potential indicator of unsafe driving, one or more predictive models may be elected based on the inferred characteristic(s). A predictive model may be a ML model that is used to analyze characteristics of driving behaviors to predict next driving actions of a vehicle. A predictive model may include a reckless behavior prediction model, aggressive behavior prediction model and distracted behavior prediction model. Each predictive model may represent a different category of unsafe driving behaviors. Based on the one or more potential indicators of unsafe driving determined for an ego vehicle, one or more prediction models may be selected. Some potential indicators of unsafe driving may represent more than one category of unsafe driving behaviors. Depending on the combination of one or more potential indicators of unsafe driving determined for an ego vehicle, the most relevant predictive model(s) may be elected.

The reckless behavior prediction model may be elected when the determined potential indicators are indicative of the ego vehicle being driven in a reckless manner. The reckless behavior prediction model may be selected when the determined potential indicators include, for example, a high degree of repetition of swerving with a motion pattern of swerving and speeding for a duration of over one minute, with a high degree of influence on at least five other vehicles. Another example of determined potential indicators that may lead to the reckless behavior prediction model being selected may include a high degree of repetition of nudging with a motion pattern of nudging, accelerations, decelerations, tailgating, and lack of headlights for a duration of over 30 seconds, with at least a medium degree of influence on at least seven other vehicles. Many variations are possible.

The aggressive behavior prediction model may be selected when the determined potential indicators are indicative of the ego vehicle being driven in an aggressive manner. The aggressive behavior prediction model may be selected when the determined potential indicators include, for example, a high degree of repetition of accelerations, decelerations, and nudging within a motion pattern for a duration of over 20 seconds that has at least a medium degree of influence on at least eight other vehicles. Another example of determined potential indicators that may lead to the aggressive behavior prediction model being selected may include a medium degree of repetition of speeding, weaving and tailgating within a motion pattern for a duration of over 30 seconds that has a high degree of influence on at least four other vehicles. Many variations are possible.

The distracted behavior prediction model may be selected when the determined potential indicators is indicative of the ego vehicle being driven in a distracted manner. The distracted behavior prediction model may be selected when the determined potential indicators include, for example, a medium degree of repetition of lane drifting and failure to signal within a motion pattern for a duration of over 40 seconds that has at least a medium degree of influence on at least five other vehicles. Another example of determined potential indicators that may lead to the distracted behavior prediction model being selected may include a low degree of repetition of weaving, failure to signal, tailgating, nudging, driving slow and delayed stopping within a motion pattern for a duration of over 30 seconds that has at least a medium degree of influence on at least six other vehicles. Many variations are possible.

There may be a combination of potential indicators of unsafe driving that could represent more than one category of unsafe driving behavior. When more than one category of unsafe driving behavior may be represented by the combination of potential indicators, each predictive model of each respective represented category of unsafe driving may be selected. Potential combinations of predictive models that may be selected may include, for example, the reckless behavior prediction model and aggressive behavior prediction model, the aggressive behavior prediction model and the distracted behavior prediction model, etc. Many variations are possible.

At step 714, the hardware processor(s) 702 may execute machine-readable/machine-executable instructions stored in the machine-readable storage media 704 to determine a predictive action of the ego vehicle using the prediction model and environmental data of the ego vehicle. The elected predictive model(s) may be used to predict the next driving data of the ego vehicle. The next driving data may include next driving actions that the ego vehicle may perform. The next driving data of the ego vehicle may be predicted according to one or more algorithms of the predictive model(s) based on the potential indicator characteristics of unsafe driving that the ego vehicle was determined to have performed and the environmental data of the ego vehicle. Environmental data of the ego vehicle may be obtained from one or more sensors of the ego vehicle, other vehicles, road, infrastructures, etc. Many variations are possible.

Each of the predictive models may include one or more algorithms used to determine the predicted next driving data based on the environmental data of the ego vehicle and the determined potential indicator characteristics of unsafe driving. The one or more algorithms may be pre-stored. The one or more algorithms may include a plurality of equations and methods to determine the predicted next driving data. In other applications, each of the predictive models may include ML and/or AI logic. ML and/or AI logic may be used to determine the predicted next driving data. The ML and/or AI logic may use data from previous sessions, whether on the same ego vehicle or other vehicles, and stored data to more quickly and efficiently determine the predicted next driving data to be performed by the ego vehicle, including, for example, types of actions predicted to be performed and a path of travel to be taken.

Upon a determination of the predicted next driving data of the ego vehicle, one or more other vehicles in a nearby vicinity of the ego vehicle may be notified of the ego vehicle performing potentially unsafe driving behaviors. The notification may include a location of the ego vehicle in relation to the respective vehicle being notified. Each vehicle being notified may also receive information of the predicted next driving actions of the ego vehicle. The notification may include suggestive actions for the respective vehicle to perform to navigate away from the ego vehicle based on the predicted next driving actions of the ego vehicle. The notification may include a message that may be displayed on a screen of the respective vehicle receiving the notification. The notification to another vehicle may assist the other vehicle with avoiding the ego vehicle.

At step 716, the hardware processor(s) 702 may execute machine-readable/machine-executable instructions stored in the machine-readable storage media 704 to monitor the ego vehicle to determine a next action of the ego vehicle. The driving behavior of the ego vehicle may be monitored to determine if the actual next driving actions performed by the ego vehicle match the predicted next driving actions determined by the one or more predictive models. While monitoring the driving behavior of the ego vehicle, the actual next driving actions performed by the subject vehicle may be identified. The identified actual next driving actions of the ego vehicle may be compared with the predicted next driving actions.

At step 718, the hardware processor(s) 702 may execute machine-readable/machine-executable instructions stored in the machine-readable storage media 704 to analyze the next action of the ego vehicle to determine whether the next action matches the predictive action. It may be determined if the actual next driving actions performed by the ego vehicle match the predicted next driving actions. If the actual next driving actions match the predicted next driving actions of the ego vehicle, then it can be determined that the potential indicator characteristics of unsafe driving, the predictive model(s), and predictive analysis of next driving actions of a vehicle are accurate and may be reenforced to improve in the efficiency in determining potential indicator characteristics of unsafe driving and performing predictive analysis of next driving actions of a vehicle. If the actual next driving actions do not match the predicted next driving actions of the ego vehicle, then it can be determined that the potential indicator characteristics of unsafe driving, the predictive model(s), and/or predictive analysis of next driving actions of a vehicle need to be refined to improve in the accuracy and efficiency in determining potential indicator characteristics of unsafe driving and performing predictive analysis of next driving actions of a vehicle.

At step 720, the hardware processor(s) 702 may execute machine-readable/machine-executable instructions stored in the machine-readable storage media 704 to refine the prediction model according to the analysis of the next action of the ego vehicle. If the actual next driving actions performed by the ego vehicle are determined to not match the predicted next driving actions, then it may be determined that at least one of the following needs to be updated and refined: (i) the potential indicator characteristics of unsafe driving, (ii) the predictive model(s) selected based on the potential indicator characteristics of unsafe driving, and (iii) the algorithm(s) in the predictive model(s) and logic used to perform predictive analysis of the next driving data. Refining at least one of the potential indicators, predictive model(s) selection, and predictive model(s) algorithm(s) and logic may improve the accuracy and efficiency in detecting and characterizing driving behaviors of vehicles to determine unsafe drivers on the road.

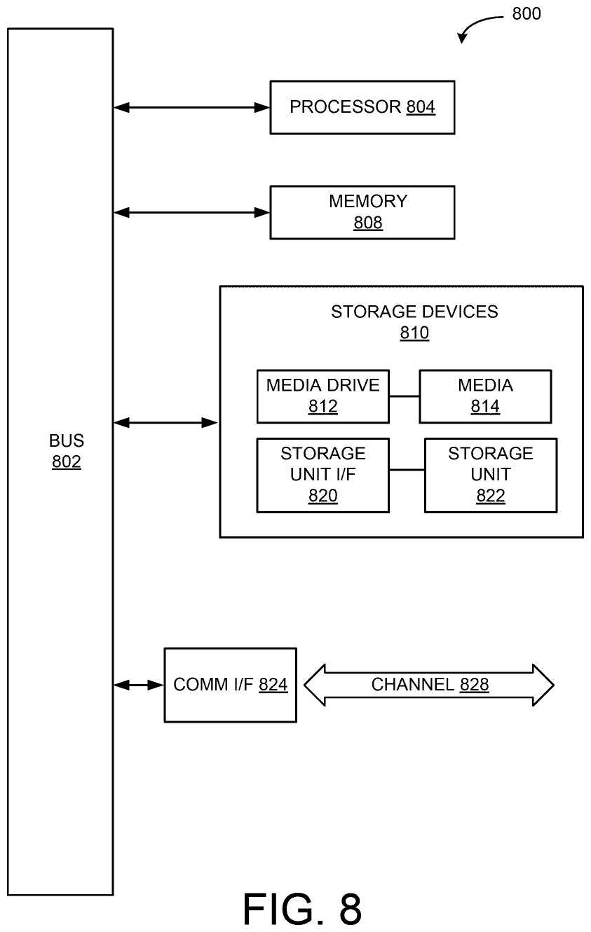

As used herein, the terms circuit, system, and component might describe a given unit of functionality that can be performed in accordance with one or more applications of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software (such as user device applications described herein), these software elements can be implemented to operate with a computing or processing component capable of carrying out the functionality described with respect thereto. One such example computing component is shown in FIG. 8. Various applications are described in terms of this example-computing component 800. After reading this description, it will become apparent to a person skilled in the relevant art how to implement the application using other computing components or architectures.

Referring now to FIG. 8, computing component 800 may represent, for example, computing or processing capabilities found within a vehicle (e.g., vehicle, 150, vehicle 200), user device, self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability. In another example, a computing component might be found in components making up a user device, vehicle 150, vehicle 200, predictive driving behavior circuit 310, decision and control circuit 303, computing system 100, computing system 210, ECU 225, etc.

Computing component 800 might include, for example, one or more processors, controllers, control components, or other processing devices. This can include a processor, and any one or more of the components making up vehicle 150 of FIG. 1, vehicle 200 of FIG. 2, computing system 210 of FIG. 2, predictive driving behavior system 300 of FIG. 3, predictive driving behavior system 500 of FIG. 5, and predictive driving behavior system 600 of FIG. 6. Processor 804 might be implemented using a general-purpose or special-purpose processing engine such as, for example, a microprocessor, controller, or other control logic. The processor 804 might be specifically configured to execute one or more instructions for execution of logic of one or more circuits described herein, such as predictive driving behavior circuit 310, decision and control circuit 303, and logic for control systems 240. Processor 804 may be configured to execute one or more instructions for performing one or more methods, such as the process described in FIG. 4, FIG. 5 and FIG. 6, and the method described in FIG. 7.

Processor 804 may be connected to a bus 802. However, any communication medium can be used to facilitate interaction with other components of computing component 800 or to communicate externally. In applications, processor 804 may fetch, decode, and execute one or more instructions to control processes and operations for enabling vehicle servicing as described herein. For example, instructions can correspond to steps for performing one or more steps of the process described in FIG. 4, FIG. 5, and FIG. 6, and the method described in FIG. 7.

Computing component 800 might also include one or more memory components, simply referred to herein as main memory 808. For example, random access memory (RAM) or other dynamic memory, might be used for storing information and instructions to be fetched, decoded, and executed by processor 804. Such instructions may include one or more instructions for execution of one or more logical circuits described herein. Instructions can include instructions 208 of FIG. 2, and instructions 309 of FIG. 3 as described herein, for example. Main memory 808 might also be used for storing temporary variables or other intermediate information during execution of instructions to be fetched, decoded, and executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative applications, information storage mechanism 810 might include other similar instrumentalities for allowing computer programs or other instructions or data to be loaded into computing component 800. Such instrumentalities might include, for example, a fixed or removable storage unit 822 and an interface 820. Examples of such storage unit 822 and interface 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or soft modem, a network interface (such as Ethernet, network interface card, IEEE 802.XX or other interface). Other examples include a communication port (such as for example, a USB port, IR port, RS232 port Bluetooth® interface, or other port), or other communications interface. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 822, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

As described herein, vehicles can be flying, partially submersible, submersible, boats, roadway, off-road, passenger, truck, trolley, train, drones, motorcycle, bicycle, or other vehicles. As used herein, vehicles can be any form of powered or unpowered transport. Obstructions can include one or more potholes, cracks, tire markings, faded road markings, debris, objects, occlusion, road reflection, floodings, icy surfaces, oil leaks, uneven pavement, erosions, raveling and other potentially hazardous conditions on the road. Although roads are references herein, it is understood that the present disclosure is not limited to roads or to 1d or 2d traffic patterns.

The term “operably connected,” “coupled”, or “coupled to”, as used throughout this description, can include direct or indirect connections, including connections without direct physical contact, electrical connections, optical connections, and so on.

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, or C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof. While various applications of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various applications be implemented to perform the recited functionality in the same order, and with each of the steps shown, unless the context dictates otherwise.

Although the disclosed technology is described above in terms of various exemplary applications and implementations, it should be understood that the various features, aspects and functionality described in one or more of the individual applications are not limited in their applicability to the particular application with which they are described, but instead can be applied, alone or in various combinations, to one or more of the other applications of the disclosed technology, whether or not such applications are described and whether or not such features are presented as being a part of a described application. Thus, the breadth and scope of the technology disclosed herein should not be limited by any of the above-described exemplary applications.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various applications set forth herein are described in terms of exemplary block diagrams, flow charts and other illustrations. As will become apparent to one of ordinary skill in the art after reading this document, the illustrated applications and their various alternatives can be implemented without confinement to the illustrated examples. For example, block diagrams and their accompanying description should not be construed as mandating a particular architecture or configuration.

What is claimed is:

1. A computer-implemented method for refining predictive driving actions, the method comprising:
analyzing driving data of a vehicle to determine a driving behavior of the vehicle;
inferring, based on the determined driving behavior, a characteristic of the driving behavior;
electing a prediction model according to the characteristic;
determining, using the prediction model, a predictive action of the vehicle according to environmental data of the vehicle;
monitoring the vehicle to determine a next action of the vehicle;
analyzing the next action to determine whether the next action matches the predictive action; and
refining the prediction model according to the analysis of the next action.

2. The computer-implemented method of claim 1, wherein the driving data of the vehicle comprises an identity of a driver of the vehicle.

3. The computer-implemented method of claim 1, wherein the driving behavior of the vehicle comprises one or more actions performed by the vehicle while in motion.

4. The computer-implemented method of claim 1, wherein the characteristic of the driving behavior comprises a type of action performed by the vehicle, degree of repetition of the type of action, motion pattern, period of the motion pattern and degree of influence.

5. The computer-implemented method of claim 4, wherein the type of action comprises nudging, accelerations, decelerations, braking, weaving, swerving, failure to signal, tailgating, lane drifting, failure to stop, speeding, driving slow, delayed stopping, delayed accelerations, honking, flashing headlights and lack of headlights.

6. The computer-implemented method of claim 1, wherein the prediction model comprises at least one of a group comprising reckless behavior prediction model, aggressive behavior prediction model and distracted behavior prediction model.

7. The computer-implemented method of claim 6, wherein each prediction model is generated according to driving data of a plurality of vehicles.

8. The computer-implemented method of claim 1, wherein the environmental data comprises traffic, traffic signs, weather, road conditions and information on surroundings of the vehicle.

9. The computer-implemented method of claim 2, wherein the determining the predictive action of the vehicle is further based on stored driving data of the driver of the vehicle.

10. The computer-implemented method of claim 1, further comprising:
determining the predictive action of the vehicle is an unsafe action; and
notifying a first driver of a first vehicle of the predictive action of the vehicle, wherein the first vehicle is in a position of danger from the predictive action of the vehicle.

11. The computer-implemented method of claim 10, wherein the determining the predictive action of the vehicle is an unsafe action is based on a driving detection algorithm associated with the prediction model.

12. The computer-implemented method of claim 10, wherein the unsafe action comprises multiple nudging, frequent accelerations, frequent decelerations, frequent braking, frequent weaving, frequent swerving, frequent headlight flashing, prolonged tailgating, aggressive speeding and driving through intersections without stopping.

13. The computer-implemented method of claim 1, wherein the refining the prediction model comprises generating a new rule on driving behavior characteristic inference.

14. A computing system for refining predictive driving actions comprising:
one or more processors; and
memory coupled to the one or more processors to store instructions, which when executed by the one or more processors, cause the one or more processors to perform operations, the operations comprising:
analyzing driving data of a vehicle to determine a driving behavior of the vehicle;
inferring, based on the determined driving behavior, a characteristic of the driving behavior;
electing a prediction model according to the characteristic;
determining, using the prediction model, a predictive action of the vehicle according to environmental data of the vehicle;
monitoring the vehicle to determine a next action of the vehicle;
analyzing the next action to determine whether the next action matches the predictive action; and
refining the prediction model according to the analysis of the next action.

15. The computing system of claim 14, wherein the characteristic of the driving behavior comprises a type of action performed by the vehicle, degree of repetition of the type of action, motion pattern, period of the motion pattern and degree of influence.

16. The computing system of claim 15, wherein the type of action comprises nudging, accelerations, decelerations, braking, weaving, swerving, failure to signal, tailgating, lane drifting, failure to stop, speeding, driving slow, delayed stopping, delayed accelerations, honking, flashing headlights and lack of headlights.

17. The computing system of claim 14, wherein the prediction model comprises at least one of a group comprising reckless behavior prediction model, aggressive behavior prediction model and distracted behavior prediction model.

18. The computing system of claim 14, further comprising:
determining the predictive action of the vehicle is an unsafe action; and
notifying a first driver of a first vehicle of the predictive action of the vehicle, wherein the first vehicle is in a position of danger from the predictive action of the vehicle.

19. The computing system of claim 18, wherein the unsafe action comprises multiple nudging, frequent accelerations, frequent decelerations, frequent braking, frequent weaving, frequent swerving, frequent headlight flashing, prolonged tailgating, aggressive speeding and driving through intersections without stopping.

20. A non-transitory machine-readable medium having instructions stored therein, which when executed by a processor, cause the processor to perform operations, the operations comprising:
analyzing driving data of a vehicle to determine a driving behavior of the vehicle;
inferring, based on the determined driving behavior, a characteristic of the driving behavior;
electing a prediction model according to the characteristic;
determining, using the prediction model, a predictive action of the vehicle according to environmental data of the vehicle;
monitoring the vehicle to determine a next action of the vehicle;
analyzing the next action to determine whether the next action matches the predictive action; and
refining the prediction model according to the analysis of the next action.
